(19) United States
(12) Patent Application Publication
(10) Pub. No.: US 2026/0267700 A1
(43) Pub. Date: Sep. 10, 2026

(54) NETWORK ORCHESTRATION SYSTEM

(71) Applicant: Intel Corporation, Santa Clara, CA (US)

(72) Inventors: Suraj SINDIA, Aloha, OR (US); Balkaran GILL, Cornelius, OR (US); Akhilesh S. THYAGATURU, Sun City Center, FL (US)

(21) Appl. No.: 19/370,429

(22) Filed: Oct. 27, 2025

(51) Int. Cl. G06F 9/50

(52) U.S. Cl. CPC G06F 9/5027

(57) ABSTRACT

Examples described herein relate to allocating resources to agentic artificial intelligence (AI)-trained systems. Some examples include receiving an indication of an upcoming AI model from a first agentic AI-trained system of the agentic AI-trained systems using inter-AI system protocol messages and allocating resources for performance of the upcoming AI model, wherein the resources comprise networking, memory, and compute resources and wherein the agentic AI-trained systems are distributed among different domains and associated with network slices.

### BACKGROUND

3rd Generation Partnership Project (3GPP) defines a fifth-generation wireless technology (5G) in Release 15 (2018) and 3GPP defines NextG Core (5GC) in Release 16 (2020) for cellular networks to provide wireless communications between User Equipment (UE) devices and base stations. A 5G Radio Access Network (RAN) connects individual devices to other devices of a network through radio connections.

5G networks and 5GC architectures isolate services for secure and tenant-aware network slicing for enterprise, industrial, and public safety networks. Network slicing allows a single physical network infrastructure (e.g., computing platform) to be divided into multiple slices of virtual and isolated networks. A slice can be tailored to specific user needs, applications, or use cases with different performance characteristics, such as, latency, reliability, and bandwidth.

### BRIEF DESCRIPTION OF THE DRAWINGS

FIG. 1 depicts an example system.

FIG. 2 depicts an example message flow for predictive orchestration.

FIG. 3 depicts an example of distributed image analysis for a security or disaster response scenario.

FIG. 4 depicts a timing diagram showing processing of video frames.

FIG. 5 depicts an example of results of average task completion times with different orchestration strategies.

FIG. 6 depicts an example system.

FIG. 7 depicts an example of operations of a Federated Learning cycle.

FIG. 8A depicts an example of control plane scalability.

FIG. 8B depicts an example of slice latency adaptation speed.

FIG. 8C depicts an example of proactive event handling and quality of service (QoS) preservation.

FIG. 9 depicts an example system.

FIG. 10 depicts an example process.

FIG. 11 depicts an example process.

FIG. 12A depicts an example energy consumption comparison.

FIG. 12B depicts an example showing carbon footprint utilization.

FIG. 12C depicts an example of a chart depicting energy saving versus performance.

FIG. 13 depicts a system.

### DETAILED DESCRIPTION

Edge computing environments support diverse applications (e.g., Augmented Reality (AR), Industrial IoT (IIoT), and real-time analytics) and demand Quality of Service (QoS) and computational power. Agentic artificial intelligence (AI) systems (e.g., AI swarms, collaborative assistants, multi-component reasoning engines) can be utilized to manage resource allocations for particular services in edge networks based on particular service level agreement (SLA) parameters. Agentic AI systems can dynamically formulate plans, invoke diverse AI models, access distributed data sources, and collaborate with other agentic AI systems. Edge Domains (EDs) are operational zones, such as an edge data center, a factory floor, or a smart city sector. An ED can host multiple applications with potentially diverse network slice characteristics.

For different edge environments, agentic AI systems can experience variable and unpredictable network resource demands (e.g., latency and bandwidth) and compute requirements. Reactive network slicing and resource management solutions can make resource adjustments after congestion or performance degradation, which can be detrimental to time-sensitive agent decision loops and collaborative tasks of agentic AI systems.

Various examples can provide adaptive networking and compute orchestration for, e.g., distributed agentic AI systems by transmitting telemetry and future performance specifications via Model Context Protocol (MCP) messages. Agentic AI components can use MCP messages as inter-AI system messages to declare current context, intended operations, utilized AI models, and future resource needs. MCP Messages can include fields related to agent intent, model requirements, task identifiers (IDs), criticality, expected data volumes, latency constraints, etc. An AI control system (AP²-SOS) can receive MCP messages and proactively predict and allocate networking and compute resources for an agentic AI model. The AI control system can receive MCP messages, utilize AI-driven predictive engines to forecast imminent network and compute demands, and utilize a Reinforcement Learning (RL) orchestrator to proactively configure agent-specific network slices and allocate networking and processor type (e.g., accelerator, central processing unit (CPU) cores, Vision Processing Unit (VPU), or Graphics Processing Unit (GPU)) to the agentic AI components. The AI control system and orchestrator can configure network slice configurations (e.g., bandwidth allocation, quality of service (QoS) priority, jitter bounds for specific Internet Protocol (IP) flows identified as belonging to an agent's declared operation).

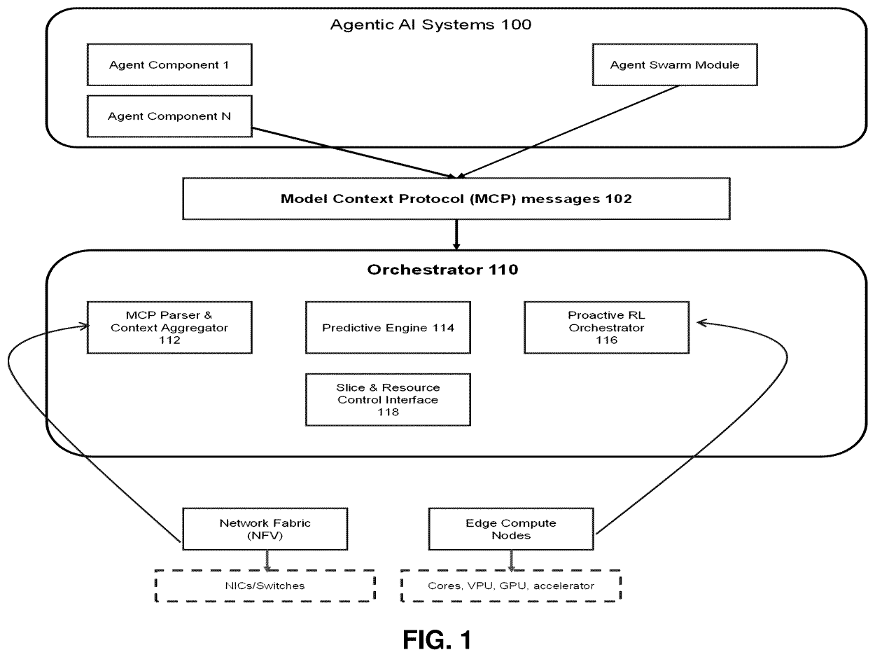

FIG. 1 depicts an example system. Agentic AI systems 100 can dynamically formulate plans, invoke diverse AI models, access distributed data sources, and collaborate. An SLA or service level objective (SLO) for an agentic AI component of AI systems 100 can specify at least one or more of: allocated memory bandwidth, allocated memory, allocated storage bandwidth, allocated storage, allocated network interface device bandwidth, allocated number of cores, processor utilization percentage, processor operating frequency, system uptime, number of generated frames per second (FPS), number of operations performed per second (OPS), or other criteria. Agentic AI systems 100 can utilize Application Programming Interface (API) calls or Software Development Kits (SDKs) to generate and send MCP messages to the AI control system (orchestrator) 110. AI agents of agentic AI systems 100 can utilize MCP messages to communicate operational context and resource needs to AI control system or orchestrator 110. MCP payloads can include information such as current operational goals, predicted resource demands, observed anomalies with confidence scores, offered service capabilities, constraints, resource availability, or summaries of local intentions.

MCP parser and context aggregator 112 can receive MCP messages from a component of agentic AI systems 100. MCP parser and context aggregator 112 can validate, parse, and aggregate context to determine active agent tasks, planned operations, and intents. Predictive engine 114 can process data from historical MCP messages, agent profiles, and current aggregated context to forecast resource needs of edge networks and systems managed by agent components 1 to N of agentic AI systems 100, where N is an integer. In some examples, predictive engine 114 can utilize a Graph Neural Network (GNN) to model agent collaborations and predict inter-agent traffic. In some examples, predictive engine 114 can utilize sequence models (e.g., Long Short-Term Memories (LSTMs), Transformers, or others) to predict resource needs based on sequences of MCP declarations for an agent's plan. For example, if MCP declares next_operation_type: MODEL_INFERENCE with a large model_name and expected_compute_profile: HIGH_VPU, engine 114 can predict a demand spike for VPU resources on an edge node and potentially high bandwidth to fetch the model or its inputs. Inputs for inference operations can include: model type (e.g., transformer, convolutional neural network (CNN), decision trees, etc.), update to model parameters, contextual data for inference with the existing model (e.g., camera image data, sensor data, thermal data, or others), or others.

Proactive RL orchestration agent 116 can access state indicated in MCP messages and generate actions from action space based on a reward function. State can include current slice configurations, aggregated MCP context (e.g., active tasks, declared needs per agent), outputs from predictive engine 114, real-time network/compute telemetry, and Network Service Provider (NSP) policies. Actions can dynamically create, modify, or terminate agent-specific or task-specific network slices (e.g., bandwidth, latency, jitter, priority between agent flows). Actions can allocate or de-allocate compute resources (e.g., central processing unit (CPU) cores, specific Neural Processing Unit (NPU) or Vision Processing Unit (VPU) contexts on graphics processing units (GPUs) or accelerators). Actions can include orchestrate model staging (e.g., pre-fetch models to edge) and select an AI model version (e.g., based on precision or pruning) to load based on current predicted resources and MCP-declared performance targets.

For example, to determine actions or policy, proactive RL orchestration agent 116 can perform a reward function as follows: R_t=w_task*f_task(AgentTaskSuccess_t)+w_perf*f_perf(AgentQoS_t)−w_res*f_res(ResourceCost_t)−w_energy*f_energy(Energy_t), where:
f_task: Reward for successful agent task completion (inferred from CONTEXT_COMPLETE MCP or external logs);
f_perf: Reward for meeting QoS requirements as specified by the agent via MCP for the given operation (e.g., max_latency_ms for a MODEL_INFERENCE operation or min_throughput_mbps for a DATA_FETCH);
f_res: Penalty for overall resource usage (network, compute); or
f_energy: Penalty for energy (leveraging Intel RAPL, etc.).

Slice and resource control interface 118 can translate actions into configurations for the network fabric (e.g., software defined networking (SDN) controllers, 5G core functions) and edge compute orchestrators (e.g., Kubernetes).

Examples of MCP fields can be as follows.

| Field name | Example content |
|---|---|
| agent_id | Unique identifier of the agent/component. |
| session_id | Identifier for a larger multi-agent task or session. |
| current_task_id | Identifier for the current immediate task. |
| next_operation_type | Enum |
| | (e.g., MODEL_INFERENCE, DATA_FETCH, AGENT_{—} |
| | COLLABORATION, COMPLEX_REASONING_CHAIN). |
| model_specifiers | Array of |
| | {model_name, model_version, expected_compute_profile (e.g., |
| | HIGH_VPU, MODERATE_CPU), model_location_hint (optional)}. |
| data_descriptors | Array of |
| | {data_source_id, expected_volume_ingress_gb, expected_volume_{—} |
| | egress_gb}. |
| qos_requirements | {max_latency_ms, min_throughput_mbps, reliability_target_percent}. |
| collaboration_intent | Array of |
| | {peer_agent_id, expected_interaction_pattern (e.g., REQUEST_{—} |
| | RESPONSE, STREAMING), shared_context_id}. |
| urgency_priority_level | From 1 (low) to 5 (critical). |
| prediction_horizon_ms | Time amount far ahead this context is valid/being planned for by |
| | the agent. |

Examples of message types can be as follows.

| | |
|---|---|
| CONTEXT_DECLARE | Agent declares its upcoming operation and needs. |
| CONTEXT_UPDATE | Agent updates its needs for an ongoing operation. |
| CONTEXT_COMPLETE | Agent signals completion of an operation. |
| ORCHESTRATOR_ACK/NACK | Orchestrator acknowledges MCP and optionally |
| | signals resource availability status. |
| CONTEXT_PROBE_REQUEST | Agent queries orchestrator about potential resource |
| | availability for a hypothetical future operation without |
| | full commitment. |
| CONTEXT_PROBE_RESPONSE | Orchestrator responds with an estimation of resource |
| | availability for the probed request. |
| CONTEXT_ADVISORY | These messages are designed to share observations, |
| | predictions, or learned insights. |
| | Fields include: source_agent_id (the agent sending the |
| | advisory), timestamp, context_type (specifying the |
| | nature of the advisory, such |
| | as PREDICTED_CONGESTION, ANOMALY_{—} |
| | DETECTED, |
| | or RESOURCE_AVAILABILITY_CHANGE), target_{—} |
| | scope (defining the area or entity the advisory pertains |
| | to, e.g., slice_id, domain_id, region_id), and |
| | a payload that contains the details of the advisory, |
| | its confidence_score, and |
| | the predicted_time_of_impact. |
| | Example Use: An Agentic Local Slice Management |
| | Engine (ALSME) might predict a significant CPU load |
| | increase in a specific domain and use this message to |
| | communicate it. |
| RESOURCE_INTENT | The purpose of these messages is to announce an |
| | agent's intention to use, release, or request resources, |
| | enabling other agents to plan accordingly. |
| | Fields include: |
| | source_agent_id, intent_type (e.g., REQUEST_{—} |
| | CAPACITY, RELEASE_CAPACITY, ANTICIPATE_NEED), |
| | resource_type (such |
| | as bandwidth, CPU_cores, VPU_instance), quantity, |
| | duration, and priority. |
| | Example Use: An ALSME might declare its intent to |
| | request additional bandwidth for a specific emergency |
| | video slice. |
| COORDINATION_REQUEST/ | These are used to initiate and manage direct |
| COORDINATION_RESPONSE | collaborative actions between agents. |
| | Request |
| | Fields: source_agent_id, target_agent_id(s) (the |
| | agent(s) the request is |
| | for), action_type (e.g., SLICE_HANDOVER, LOAD_{—} |
| | BALANCING_ASSIST, JOINT_PROBLEM_DIAGNOSIS), |
| | proposed_parameters, and a deadline. |
| | Response Fields: original_request_id (to link to the |
| | initial request), status (indicating ACCEPT, REJECT, |
| | or COUNTER_PROPOSE), and revised_parameters if |
| | a counter-proposal is made. |
| GOAL_UPDATE_NOTIFICATION | These messages inform relevant agents about changes |
| | in operational goals. |
| | Fields include: |
| | source_authority (e.g., Operator, Regional_Hub), |
| | target_agent_scope, goal_description, priority_level, |
| | and constraints. |
| CAPABILITY_ADVERTISEMENT | Agents use these messages to advertise their |
| | specialized skills or the resources they manage. |
| | Fields include: |
| | source_agent_id, capability_type (e.g., VIDEO_{—} |
| | TRANSCODING_ACCELERATION, LOW_LATENCY_{—} |
| | PATH_PROVISIONING), service_description, |
| | and access_policy |

However, variations of messages can be utilized, including changes to message names, syntax, field content, inclusion of fields from other messages, non-inclusion of fields, or others.

An example pseudo-code that can be performed by an agentic AI agent for generating MCP packet fields is shown below.

```
model_specifiers: Array of {
  model_name: string,
  model_version: string,
  expected_compute_profile: Enum (e.g., HIGH_VPU_INT8, MODERATE_CPU_FP16,
LOW_NPU_ACCEL), // More specific profiles
  model_location_hint: URI_or_Identifier (optional),
  estimated_inference_time_ms_target: float (optional, target for this model operation),
  input_data_dependencies: Array of data_source_id (optional, for dependency graph)
}
qos_requirements: { // Per this operation/flow
  max_latency_ms: float,
  min_throughput_mbps: float,
  max_jitter_ms: float (optional, crucial for some agent interactions),
  reliability_target_percent: float (e.g., 99.999),
  flow_directionality: Enum (e.g., UNIDIRECTIONAL_TO_PEER, BIDIRECTIONAL,
TO_DATA_SOURCE) (optional)
}
task_dependencies: Array of { // To help AI control system determine the agent's plan
  depends_on_task_id: string, // This current_task_id depends on another agent's/own prior task
  dependency_type: Enum (e.g., DATA_READY, MODEL_READY, AGENT_SYNC_POINT)
} (optional)
collaboration_intent: Array of {
  peer_agent_id: string,
  logical_flow_id: string (unique ID for this specific collaboration link/purpose), // For finer-
grained slicing
  expected_interaction_pattern: Enum (e.g., REQUEST_RESPONSE_CRITICAL,
STREAMING_HIGH_THROUGHPUT, PERIODIC_HEARTBEAT),
  shared_context_id: string (optional),
  expected_duration_s: float (optional)
}
task_dependencies: Array of { // To help AI control system determine the agent's plan
  depends_on_task_id: string, // This current_task_id depends on another agent's/own prior task
  dependency_type: Enum (e.g., DATA_READY, MODEL_READY, AGENT_SYNC_POINT)
} (optional)
```

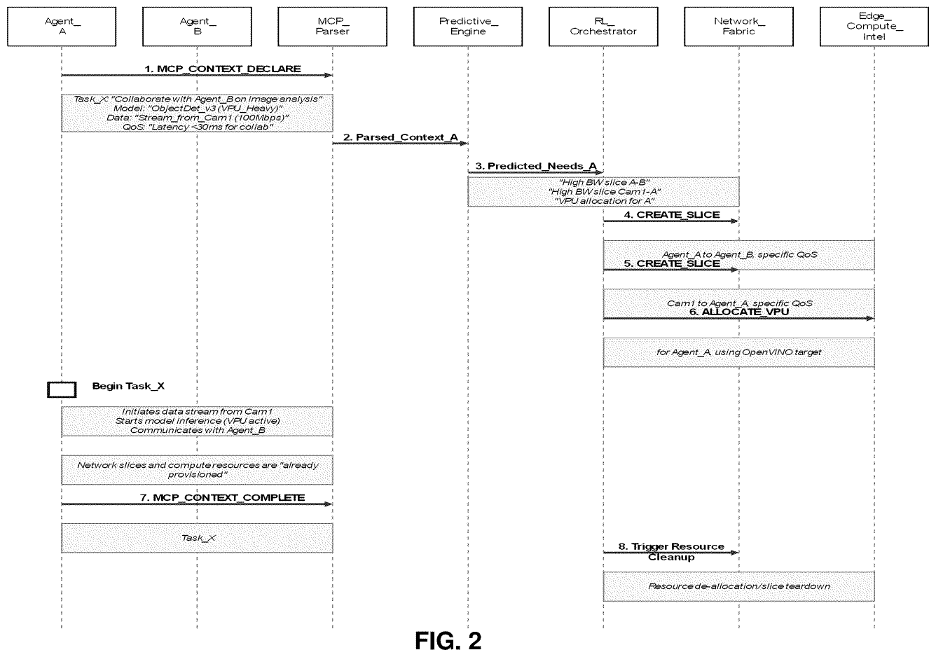

FIG. 2 depicts an example MCP Message Flow and predictive orchestration. At (1), Agent_A can transmit to MCP_Parser an MCP message of MCP_CONTEXT_DECLARE (Task_X: “Collaborate with Agent_B on ImageAnalysis”, Model: “ObjectDet_v3 (VPU_Heavy)”, Data: “Stream_from_Cam1 (100 Mbps)”, QoS: “Latency<30 ms for collab”) to indicate a that MCP messages with operational intent and resource declaration are to be transmitted in (2).

At (2), MCP_Parser can transmit Parsed_Context_A to Predictive Engine. Parsed_Context_A can represent operational intent and resource declaration.

At (3), Predictive Engine can transmit Predicted_Needs_A (High BW slice A-B, High BW slice Cam1-A, VPU allocation for A) to RL_Orchestrator. Predicted_Needs_A can indicate expected resource utilization.

At (4), RL_Orchestrator can transmit CREATE_SLICE (Agent_A to Agent_B, specific QoS) to Network Fabric to indicate configuration of a dedicated communication channel.

At (5), RL_Orchestrator can transmit CREATE_SLICE (Cam1 to Agent A, specific QoS) to Network_Fabric to indicate the configuration of a high-bandwidth data ingestion path.

At (6), RL_Orchestrator can transmit to Edge_Compute: ALLOCATE_VPU (for Agent A) to indicate the allocation of a compute accelerator for AI inference. Agent_A begins Task_X and initiates data stream from a camera module or sensor (Cam1), starts model inference (VPU active), and communicates with Agent_B to perform image analysis. Network slices and compute resources can be previously provisioned.

At (7), Agent_A can transmit to MCP_Parser: MCP_CONTEXT_COMPLETE (Task_X) to indicate completion of the task.

At (8), MCP_Parser can transmit trigger resource cleanup to perform resource de-allocation/slice teardown to indicate initiation of resource release based on task completion.

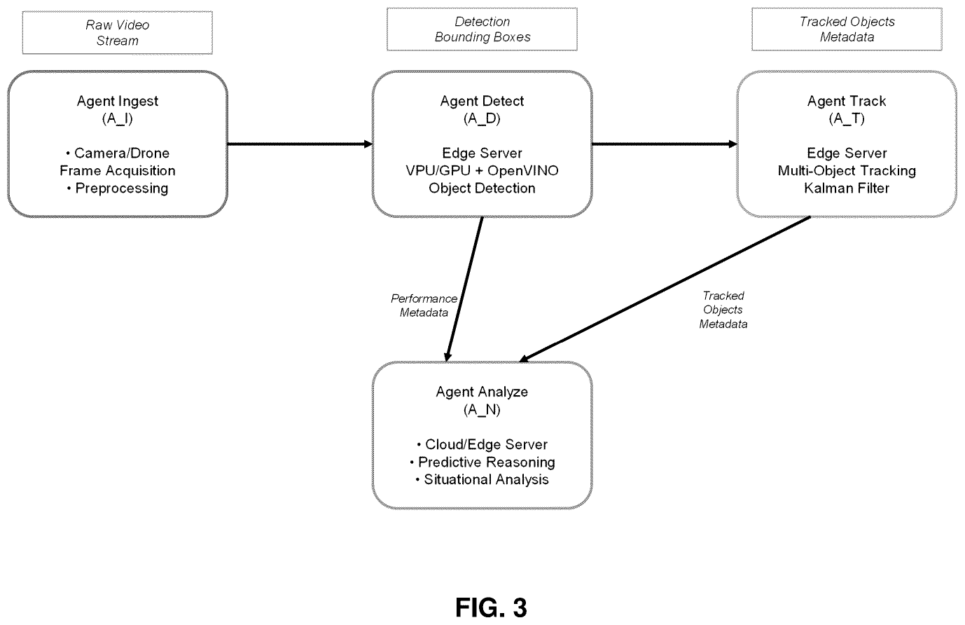

FIG. 3 depicts an example of distributed image analysis for a security or response scenario. A drone or a set of fixed cameras captures a video stream and provides the video stream to an agentic AI detection system. For example, the AI detection system can be associated with edge servers at intersections can manage traffic cameras, vehicle detection sensors, pedestrian counters and perform real-time vehicle counting, speed detection, congestion analysis for a particular service level agreement (SLA). An MCP declaration can include: next operation is vehicle detection using YOLO_v8 model, need VPU allocation, expect 50 Mbps camera stream, latency<20 ms.

An agentic AI system can be associated with traffic signal control boxes to manage traffic lights, pedestrian crossing signals, emergency vehicle detectors and perform traffic signal timing optimization, or emergency vehicle prioritization for a particular SLA. An MCP declaration can specify: collaboration needed with A_TM for signal optimization, require TSN slice for time-critical control, max jitter Ims.

An agentic AI system can perform analysis to control traffic lights. For example, the agentic AI system can be positioned in a regional data center and manage city-wide traffic database, GPS navigation services, mobile app APIs. The agentic AI system can perform route planning, congestion prediction, and alternative path calculation. For heavy traffic detected, agentic AI system can invoke congestion analysis model in 30 seconds, allocate VPU resources on edge server, and create high-bandwidth slice from cameras. For example, for an emergency, agentic AI system can clear path from Hospital to Highway for an ambulance, create priority network slices between agents on route, and allocate TCC-synchronized compute for time-critical signal changes.

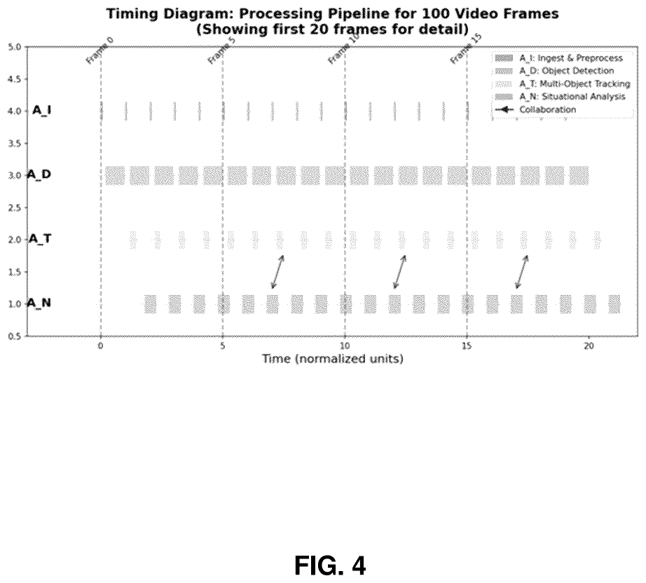

FIG. 4 depicts a timing diagram showing processing of video frames. Proactive slicing sequence diagram for agentic actions to process a stream of 100 input video frames. The task completion time can be measured from when the first frame enters A_I until A_N produces a final analysis output based on information derived from the 100th frame's processing pipeline.

Agent Ingest (A_I) can be located near the camera/drone and can receive raw video frames and perform light pre-processing (e.g., frame selection, basic compression).

Agent_Detect (A_D) can execute on an edge server, receive frames from A_I and perform object detection (e.g., identifying people, vehicles) using a computationally intensive AI model (e.g., convolutional neural network). A_D can declare its model/logic via MCP.

Agent_Track (A_T) can execute on the same or another edge server as that of A_D, receive object detection bounding boxes/metadata from A_D, perform multi-object tracking across frames, and maintain state. A_T can declare its model/logic via MCP.

Agent_Analyze (A_N) can execute on an edge or regional cloud server, receive tracked object data from A_T and higher-level situational queries (e.g., “is a red vehicle approaching zone X?”), and perform reasoning, potentially using another AI model (e.g., activity recognition or a knowledge base lookup). A_N can collaborate with A_T by sending intermediate findings or requests for more detailed tracking from A_T and declare its model and collaborative needs via MCP.

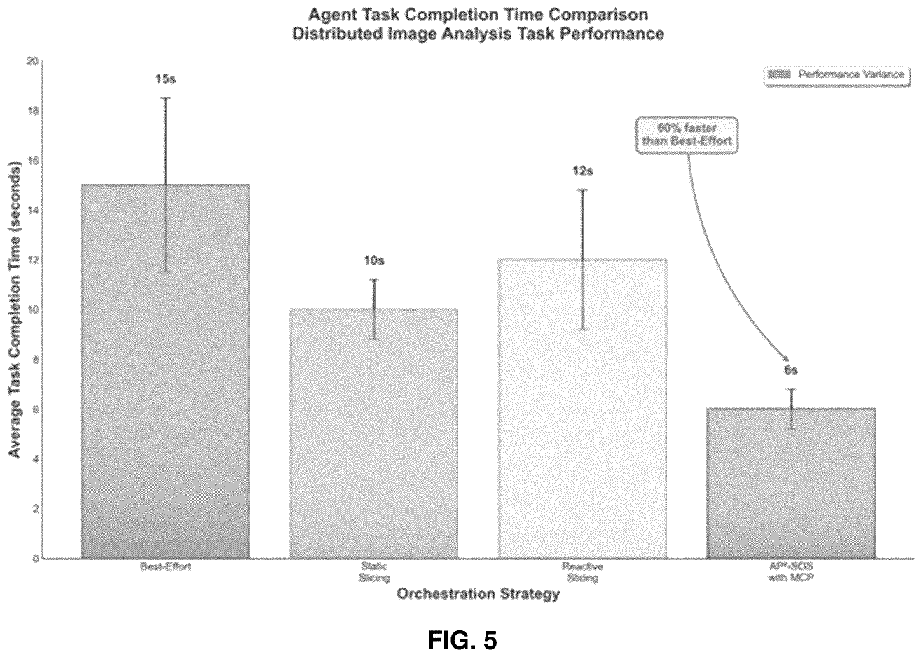

FIG. 5 depicts an example of results of average task completion times with different orchestration strategies. Simulations of a distributed image analysis task involving three AI agents (e.g., data ingestion, object detection, scene understanding) demonstrate reduced end-to-end task completion time. By parsing MCP declarations from agents about upcoming model usage (e.g., a VPU-intensive detection model on a processor with integrated NPU/GPU) and collaborative data exchanges, AP²-SOS pre-allocates dedicated network paths and compute priority. This proactive orchestration avoids resource bottlenecks encountered by reactive systems and the inherent inefficiencies or performance limitations of static or best-effort approaches, especially when agent tasks require time-sensitive collaboration (Intel TCC for TSN synchronization could be specified via MCP for such segments).

The X-axis shows different orchestration strategies (Best-Effort, Static_Slicing, Reactive_Slicing, AP²-SOS_with_MCP). The Y-axis shows time in seconds for completion of a task.

Results of average task completion times with different orchestration strategies show Best-Effort indicates high variance due to contention; Static Slicing provides over-provisioned, stable but inefficient resource allocation; Reactive Slicing experiences spikes during resource contention before reaction; and AP²-SOS with MCP proactively allocated resources reduce contention and delay.

The following is an example of Agent Action Responses for different levels of priority (e.g., levels 1-3). Level 1, a high priority immediate and reactive execution, can be a level triggered by a direct request from another agent. An example trigger can be receiving a COORDINATION_REQUEST. For requests of SLICE_HANDOVER, LOAD_BALANCING_ASSIST, and JOINT_PROBLEM_DIAGNOSIS, the agent can evaluate the request against its internal state, goals, and resource constraints. The agentic AI agent can determine whether to accept this slice handover without violating the QoS of existing slices and whether there are spare compute resources to assist with load balancing. Based on the assessment, the agent can decide an action. The agent executes the decision and communicates the decision back to the requesting agent. On ACCEPT, the agent initiates the requested action (e.g., begins the technical process for a slice handover) and sends a COORDINATION_RESPONSE with status ACCEPT. On REJECT, the agent discards the request and sends a COORDINATION_RESPONSE with status REJECT, potentially including a reason code. On COUNTER_PROPOSE, if the request is feasible but not under the proposed terms, the agent formulates an alternative and sends a COORDINATION_RESPONSE with status: COUNTER_PROPOSE and the revised_parameters.

Level 2, a medium priority proactive and strategic planning, can be a level triggered by receiving intelligence about future events or the intentions of other agents. Triggers can include receiving a CONTEXT_ADVISORY (e.g., PREDICTED_CONGESTION, RESOURCE_AVAILABILITY_CHANGE). Triggers can include receiving a RESOURCE_INTENT (e.g., another agent intends to REQUEST_CAPACITY). The agent integrates the information into its internal model and analyzes the potential impact on its goals. The agent can determine whether the predicted congestion in a neighboring domain affect my traffic routing for a latency-sensitive telemedicine slice in a particular amount of time. For example, the agent can determine if ALSME-C requests 200 Mbps in 30 minutes, and whether there is enough remaining capacity for projected needs. The agent can use its planning capabilities to determine actions to mitigate risks or capitalize on opportunities. The plan can be translated into a series of actions, which could be internal adjustments or external communications. Internal actions can include pre-emptive resource allocation to reserve bandwidth or CPU cycles in anticipation of a future need. Internal actions can include policy adjustment to temporarily change local scheduling priorities to protect a critical slice. Internal actions can include AI model tuning to adjust the reward function of its local Deep Reinforcement Learning model to prioritize stability over performance during the anticipated event.

In level 2, the agent can issue MCP messages to another agent. If the plan includes a request for assistance, the agent may send its COORDINATION_REQUEST to another agent (e.g., “Requesting to offload non-critical slice_B to target agent to prepare for event_Z”). If the plan includes future resource needs, the agent can broadcast a RESOURCE_INTENT to inform others.

Level 3 can be an agent's default operational state, focused on maintaining goals and adjusting resource allocations based on environment telemetry. Level 3 can be a continuous loop that runs in the absence of higher-priority triggers from Level 1 or 2.

### Federated Agentic Agent Learning

Centralized Network Slice Orchestration, such as European Telecommunications Standards Institute (ETSI) Network Functions Virtualization (NFV) Management and Orchestration (MANO), employ a logically centralized or hierarchical control model. A central orchestrator or controller gathers telemetry from various network segments and edge domains, processes this information, makes slice management decisions (e.g., resource allocation, policy enforcement), and then disseminates control commands to local execution entities.

Various examples include agentic AI engines at edge domains that allocate resources for slice management, or other services, and manage network slices by collaboratively training AI models using Federated Learning (FL). AI engines can transmit Model Context Protocol (MCP) messages to share semantic context (e.g., goals, predictions, intents), enabling proactive, adaptive, and coordinated slice orchestration across distributed edge environments. Federated Learning collaboratively trains the underlying AI models of these agents. An aggregation server can periodically aggregate locally-trained model updates (e.g., neural network weights, biases, or gradients) and distribute model updates to agentic AI agents for scalable, resilient, and privacy-preserving slice orchestration without exchanging raw operational telemetry. An aggregation server can update models of agentic AI systems to enhance local decision-making of agentic AI systems at edge systems by evolving AI models.

An agent can monitor local telemetry (e.g., network traffic, resource usage) and the outcomes of its past actions. This data can be used to continuously train and fine-tune its local AI model. The agent can perform real-time, autonomous decisions to manage its local slices. For example, the agent can adjust the bandwidth allocated to a slice based on real-time demand, dynamically adjusting power consumption based on goals, managing admission control for new slice requests. The agent can contribute to the collective intelligence of the system by publishing its own insights to an aggregation server. The agent can periodically send CONTEXT_ADVISORY messages to the aggregation server based on its own local predictions (e.g., “Anomaly detected in application performance for slice_X”). The agent can broadcast a CAPABILITY_ADVERTISEMENT to inform other agents and the aggregation server of the capability to perform federated learning.

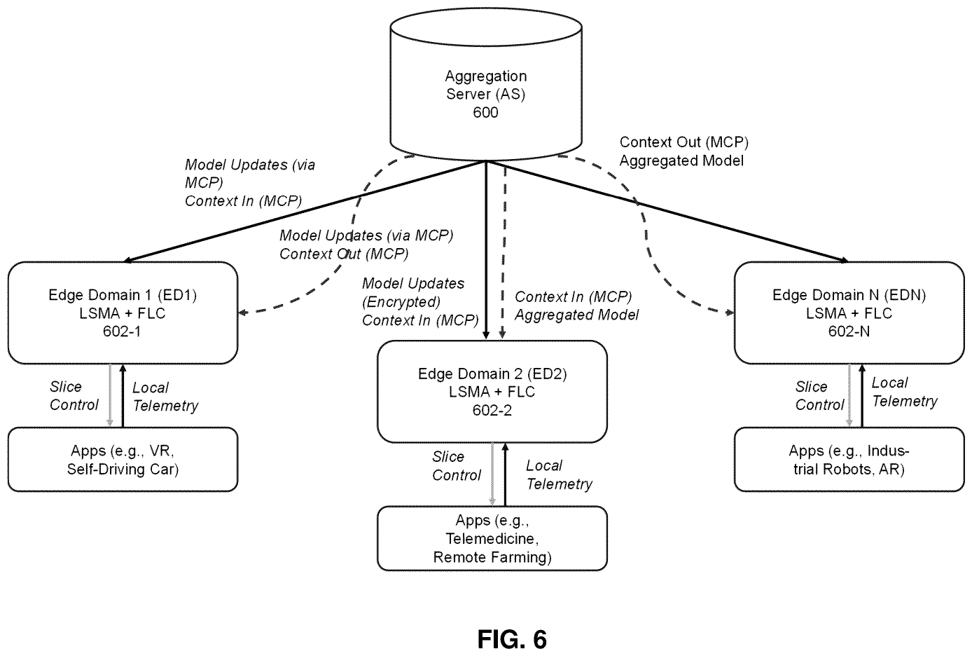

FIG. 6 depicts an example system of Local Slice Management Agents (LSMAs) that improve AI models by communication with aggregation server (AS). LSMAs (e.g., agentic AI systems) 602-1 to 602-N can be deployed in edge domains (e.g., an edge server or a network interface device). LSMAs 602-1 to 602-N can manage slices and train AI models of an associated edge domain.

LSMAs 602-1 to 602-N can be configured by configuration files or registers that indicate participation in a federated learning process with an AS 600. The configuration file indicate aggregation server Internet Protocol (IP) address, federated learning round frequency, model updates to share, or other information. LSMAs 602-1 to 602-N can utilize a telemetry collector to gather data from network elements, applications, and hardware performance counters within the edge domain. LSMAs 602-1 to 602-N can utilize respective AI models to dynamically adjust slice parameters in an edge domain. An AI model can include one or more of: a Deep Reinforcement Learning (DRL) agent (e.g., Proximal Policy Optimization (PPO), Deep Q-Network (DQN), or others) or a predictive model. The AI model can receive local slice telemetry (e.g., utilization, queue lengths, packet drop rates), application-level QoS feedback (e.g., latency, throughput reported by services), compute resource status (CPU or VPU load, power consumption), current network configurations, or other information. The AI model can generate actions of dynamic adjustment of slice parameters (e.g., guaranteed bandwidth, priority, queue depths), admission control for new slice requests, local traffic steering decisions, selection of specific AI models for applications based on network conditions, or others.

Federated Learning Client (FLC) of an LSMA can manage the local AI model's participation in the federated learning process. FLC can prepare model updates (e.g., gradients, differential weights) from the locally trained AI model, securely transmit model updates to Aggregation Server 600, and/or receive and apply the aggregated model to the local AI model.

LSMAs 602-1 to 602-N can communicate with AS 600 by respective Federated Learning Client (FLC) modules. LSMAs 602-1 to 602-N can send model updates to Aggregation Server 600. Aggregation Server 600 can utilize model switching based on resource availability (e.g., Intel® SGX) for secure aggregation of Secure Enclaves and distribute an improved global model. LSMAs in Edge Domains can use MCP messages to exchange context (with AS 600 and peer-to-peer) and FL for model training to enable proactive and coordinated slice management. Context (e.g., model updates, weights, parameters, gradients, or others) can be summarized, anonymized, or subject to privacy controls before being shared via MCP messages.

Aggregation server 600 can perform a logically centralized service and can be physically distributed or replicated for resilience. Aggregation server 600 can perform one or more of: orchestrating FL rounds with LSMAs, securely receiving model updates from FLCs across edge domains; perform federated aggregation algorithms (e.g., Federated Averaging (FedAvg), Federated Proximal (FedProx)) to combine local updates into an improved global/regional model; and/or distributing the updated global/regional model to the FLCs. The shared model resulting from the aggregation process represents collective intelligence learned from participating EDs, potentially improving slice management strategies.

LSMAs 602-1 to 602-N can communicate with AS 600 using Model Context Protocol (MCP) messages and share information such as: current operational goals, predicted resource demands, observed anomalies with confidence scores, offered service capabilities, constraints, resource availability, or summaries of local expected usages. Context (e.g., agent intent, predictions, resource needs) received via MCP messages can influence local training of an LSMA of another edge domain. For example, based on receipt of an upcoming network-wide high-priority event, the agent can adjust its Deep Reinforcement Learning (DRL) strategy or reward function during local training to learn policies robust to such events. Intel® Time Coordinated Computing (TCC) and Time-Sensitive Networking (TSN) capabilities be utilized so that telemetry collection and local control actions meet stringent timing requirements, particularly in industrial or automotive edge domains. AS 600 can update weights of LSMAs 602-1 to 602-N to learn from diverse situations encountered by other edge domains, improving their generalization and avoiding overfitting to purely local patterns.

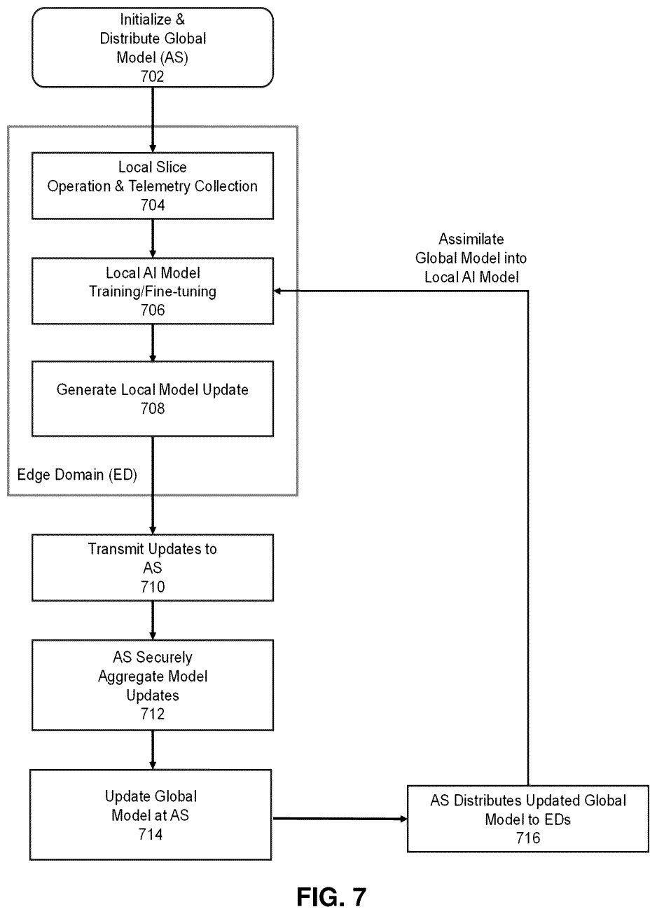

FIG. 7 depicts an example of operations of a federated learning cycle for slice control plane with local training at Edge Domains (EDs) and an Aggregation Server (AS). At 702, the AS can initialize a base global slice management AI model and distribute the model parameters (e.g., neural network weights, biases, or gradients) and telemetry to collect (e.g., predicted congestion, resource availability, or anomaly reports) to participating EDs. LSMAs associated with EDs can instantiate local AI models, potentially using the global model as a starting point. At 704, an LSMA can monitor telemetry of its local ED environment (e.g., network traffic, processor utilization, memory utilization, or others). At 706, the LSMA can make real-time slice management decisions using its current local AI model. Based on the outcomes of these decisions and newly collected telemetry, the LSMA can train or fine-tune local AI model. At 708, LSMAs can update local models. For example, periodically (e.g., after a fixed number of local training operations, time interval, or significant performance change), the FLC of an Edge Domain can prepare an update from its local AI model. This update can include model parameter changes (e.g., weights, biases, gradients, etc.). At 710, the LSMA can securely transmit updated model parameters to the AS. For example, FLCs can encrypt and transmit their model updates to the AS.

At 712, federated aggregation at AS can occur as the AS receives updates from a configured quorum of edge domains or after a time window closes. An AS can perform secure aggregation whereby updates are decrypted and aggregated within a secure enclave, protecting them from the AS host environment. At 714, AS can perform an aggregation operation to combine the local updates into a global model. Algorithms such as FedAvg (W_global=Σ(n_k/N*W_k)), FedProx (e.g., add a proximal term to local objective functions to limit local model drift), or adaptive federated optimization algorithms can be used to combine the local updates into a global model. Differential privacy techniques (e.g., adding calibrated noise to updates before aggregation, or to the aggregated model) can be applied by the FLCs or the AS to provide data privacy guarantees.

At 716, model dissemination can occur whereby the AS distributes the updated global model back to all participating FLCs. Returning to 706, local model assimilation can occur whereby FLC updates LSMA's local AI model using the received global model. This could include replacing the local model, using the global model to regularize further local training or as part of an ensemble. Note that the phrase “global” need not refer to AI agents of all edge domains but can apply to AI agents of one or more edge domains.

Agentic context exchange and action loop can occur via MCP messages and can be more frequent, near real-time as compared to federated learning loop. Agentic Local Slice Management Engines (ALSMEs) can periodically record telemetry concerning local environment and receive contextual messages (e.g., predictions, intents, alerts) from other ALSMEs or the Regional Context Hub via MCP. The agent logic within an ALSME updates its internal state based on new telemetry and MCP messages and evaluates current goals (e.g., maintain QoS for slice X, minimize power for domain Y, prepare for anticipated event Z). Based on its updated state and goals, the agent determines a sequence of actions, such as: adjusting local slice parameters, requesting/releasing resources, or preparing for future resource demands. If a plan requires coordination with other agents (e.g., to hand over a mobile slice, to balance load across domains), the ALSME can send coordination requests by MCP messages, share partial plans by MCP messages, or negotiate resource allocation by MCP messages. Other ALSMEs receiving such MCP messages can evaluate requests, plans, and negotiations based on their own goals and state, potentially leading to collaborative execution or counter-proposals. The ALSME can cause execution of the decided actions on the local network resources. The ALSME may publish contextual information via MCP messages (e.g., “successfully reconfigured slice for VR event,” “predicting capacity shortfall in 10 mins for service type A,” or “local policy change: prioritizing energy saving”).

ALSMEs can operate based on defined goals (e.g., “Maintain <5 ms latency for Slice_Critical_VR,” “Minimize energy consumption in ED_Low_Activity,” or “Ensure 99.999% availability for Slice_Telemedicine”). Goals can be static or dynamically updated (via MCP messages or operator input). An ALSME can maintain a representation of its local environment (e.g., slice status, resource utilization, network topology, active applications) and relevant non-local context received via MCP messages (e.g., neighboring domain status, regional predictions). ALSMEs can utilize planning algorithms (e.g., simple heuristic planners, or more complex Hierarchical Task Network (HTN)/Planning Domain Definition Language (PDDL)-like reasoners for specific tasks) to determine sequences of actions to achieve goals for a given state. The underlying AI model (e.g., DRL agent) can learn policies for slice parameter adjustment, admission control, etc., through interaction with the environment and guidance from the FL process. The agentic layer can utilize a learned model for decision-making.

ALSMEs can predict future states, share these predictions via MCP messages (“CONTEXT_ADVISORY: High_Throughput_Demand_Expected_Slice_X_at_T+10 mins”), and collaboratively plan to meet anticipated needs or avoid problems. An agent in one domain can determine the implications of an event in another domain if relevant context is shared via MCP messages (e.g., “INTENT_SHARE: Edge_Domain_A_shifting_heavy_compute_to_me_for_disaster_recovery_scenario”). An agent utilizing a neighboring agent's goal can make more synergistic decisions.

The following outlines examples of an Agentic AI model Local Slice Management Engine (ALSME) processing and responding to security-related events, from immediate, high-confidence threats to routine posture management and intelligence sharing. Level 1 responses can be triggered by a high-confidence, active threat requiring immediate, coordinated action to contain or neutralize the thread. A trigger can include receiving a high-priority COORDINATION REQUEST with a security action_type. For example, ISOLATE_SLICE_COMPROMISED, BLOCK_TRAFFIC_SOURCE_DDOS, INITIATE_FOR ENSIC_CAPTURE, MIGRATE_CRITICAL_SERVICE_AWAY_FROM_THREAT.

The agent can verify the authenticity and authorization of the requesting agent. The agent can evaluate the request against its goals and operational constraints. The agent can determine if the request was received from a trusted peer or a recognized security authority. The agent can determine whether to isolate this slice without causing unacceptable cascading failures to dependent, critical services (e.g., a 911 service). The agent can determine a blast radius of blocking this traffic source and whether non-compromised users are impacted. Based on its security policies and real-time assessment, the agent makes and executes a decision. The agent can execute the decision and communicate the outcome via a COORDINATION_RESPONSE.

On ACCEPT, the agent can execute a security action (e.g., applies firewall rules to isolate the slice, re-routes traffic, triggers a memory snapshot using secure enclaves like Intel SGX for forensics, SHA256 encryption) and sends a COORDINATION_RESPONSE with status: ACCEPT. Secure enclaves (e.g., Intel® SGX enclaves) can be used to protect the aggregation process and the model updates from the underlying infrastructure.

On REJECT, if the action would violate a higher-priority goal (e.g., safety-critical system integrity), the agent denies the request and sends a COORDINATION_RESPONSE with status: REJECT, including a reason code (e.g., POLICY_VIOLATION_CRITICAL_SERVICE).

If the request is not accepted, the agent can propose a more targeted action by issuing COUNTER_PROPOSE. For example, “Cannot isolate the entire slice, but can rate-limit its egress traffic to prevent data exfiltration. Proposing RATE_LIMIT_EGRESS.” The agent can send a COORDINATION_RESPONSE with status: COUNTER_PROPOSE and the revised parameters.

Level 2 responses can be triggered by receiving threat intelligence or early warnings about potential, developing, or impending security events for preparing defenses and shifting security posture before an attack fully materializes. The level can be triggered by a CONTEXT_ADVISORY with a security context type (e.g., SUSPICIOUS_TRAFFIC_PATTERN_DETECTED, POTENTIAL_DDOS_PRECURSOR, COMPROMISE_INDICATOR_SHARED).

The level can be triggered by receiving a GOAL_UPDATE_NOTIFICATION from a security authority (e.g., “increase security posture to HIGH for all telemedicine slices”). The agent can integrate the advisory into its state, evaluates the confidence score of the intelligence, and correlates it with local telemetry. The agent can determine whether the SUSPICIOUS_TRAFFIC_PATTERN described in the advisory match any low-level detected anomalies. The agent can determine whether there are the potential targets within a domain if this threat materializes. The agent can use its planning capabilities to devise a multi-operation strategy to harden its defenses or prepare for the anticipated threat. The plan can be translated into a sequence of internal adjustments and external communications. Actions can include allocate more compute resources for deep packet inspection on relevant slices; reserve bandwidth or standby compute (potentially in a secure location) to prepare for a service migration; increase firewall rules, lower trust levels for traffic from suspect regions, or enforce stricter authentication on slice access points, including SHA128 encryption; adjust the local DRL agent's reward function to heavily penalize latency spikes or packet loss on critical slices, making it learn more conservative policies in anticipation of instability.

If an agent analysis confirms the threat, the agent can propagate another CONTEXT_ADVISORY to its peers with its added findings, increasing the collective confidence. If its plan requires future resources, agent can broadcast a RESOURCE_INTENT (e.g., “Intend to request emergency bandwidth for slice_911 if DDOS_PRECURSOR event escalates”). If its plan requires assistance, agent can send a COORDINATION_REQUEST (e.g., “Requesting peer agent to mirror my traffic for joint analysis”).

Level 3 responses can be the agent's default operational state, focused on anomaly detection, and contributing to the system's collective threat intelligence through learning. The agent analyzes local telemetry to learn the normal baseline of operations for its domain. This local experience is used to train its AI model. Through the Federated Learning process, it benefits from the experiences of all other agents in detecting novel, low-and-slow attack patterns without ever sharing raw, private telemetry. Based on its learned model and defined policies, the agent can make autonomous decisions to maintain and improve its security posture. For example, the agent can identify and flag persistently anomalous (but not yet threatening) traffic for lower-level review, optimizing resource allocation for security monitoring functions, applying routine security patches or policy updates. The agent can act as a sensor for a federated system. The agent can contribute its model updates to the Federated Learning aggregation server, improving the global model's ability to detect threats, as described herein. The agent may publish low-priority CONTEXT_ADVISORY messages based on its local findings (e.g., “ANOMALY_DETECTED: Minor increase in port scanning activity from subnet Z, confidence: 0.3”). These advisories help build a global, real-time threat map. The agent may broadcast a CAPABILITY_ADVERTISEMENT to inform other agents of specialized security functions it might possess (e.g., “Providing ENCRYPTED_THREAT_ANALYSIS service via Intel SGX”, continuously running SHA64 encryption).

An example of Model Context Protocol (MCP) Message Types and Semantics is as follows. CONTEXT_ADVISORY can be used to share observations, predictions, or learned insights. Example Fields: source_agent_id, timestamp, context_type (e.g., PREDICTED_CONGESTION, ANOMALY_DETECTED, RESOURCE_AVAILABILITY_CHANGE), target scope (e.g., slice_id, domain_id, region id), payload (details of the advisory, confidence_score, predicted_time_of_impact). An example use can be “ALSME_A predicts 80% chance of >50% CPU load increase in domain B on server_XYZ in 15 mins.”

RESOURCE_INTENT can announce an agent's intention to use/release/request resources, allowing others to plan accordingly. Example Fields: source_agent_id, intent_type (e.g., REQUEST_CAPACITY, RELEASE_CAPACITY, ANTICIPATE_NEED), resource type (e.g., bandwidth, CPU_cores, VPU_instance), quantity, duration, priority. An example use can be “ALSME_C intends to request 200 Mbps extra bandwidth for slice_EmergencyVideo for the next 30 mins.”

COORDINATION_REQUEST/COORDINATION_RESPONSE can initiate and manage direct collaborative actions. Example Fields (Request) can include source_agent_id, target_agent_id(s), action_type (e.g., SLICE_HANDOVER, LOAD_BALANCING_ASSIST, JOINT_PROBLEM_DIAGNOSIS), proposed_parameters, deadline. Example Fields (Response) can include original_request_id, status (e.g., ACCEPT, REJECT, COUNTER_PROPOSE), revised_parameters.

GOAL_UPDATE_NOTIFICATION can inform relevant agents about changes in operational goals. Example Fields can include source_authority (e.g., Operator, Regional_Hub), target_agent_scope, goal_description, priority_level, or constraints.

CAPABILITY_ADVERTISEMENT can cause agents to advertise specialized skills or resources they manage. Example Fields can include source_agent_id, capability type (e.g., VIDEO_TRANSCODING_ACCELERATION, LOW_LATENCY_PATH_PROVISIONING), service_description, access_policy. Context from MCP can enrich the state representation for the local AI models being trained by FL. The global model from FL can provide foundational policies, which the agentic layer then fine-tunes and applies using real-time context from MCP.

To assess how the control plane overhead of each system scales with an increasing number of managed Edge Domains, a number of simulated Edge Domains was incrementally increased (e.g., from 10 to 500). For each increment, the system was run under both the Centralized Control and Federated Control paradigms for a fixed duration, handling a representative mix of slice requests and dynamic traffic. Key metrics included total control message volume and the CPU utilization on the central controller (for the centralized model) or the aggregation server plus cumulative load of FLCs (for the federated model). These were combined into a “Normalized Overhead/CPU Load” metric for comparison.

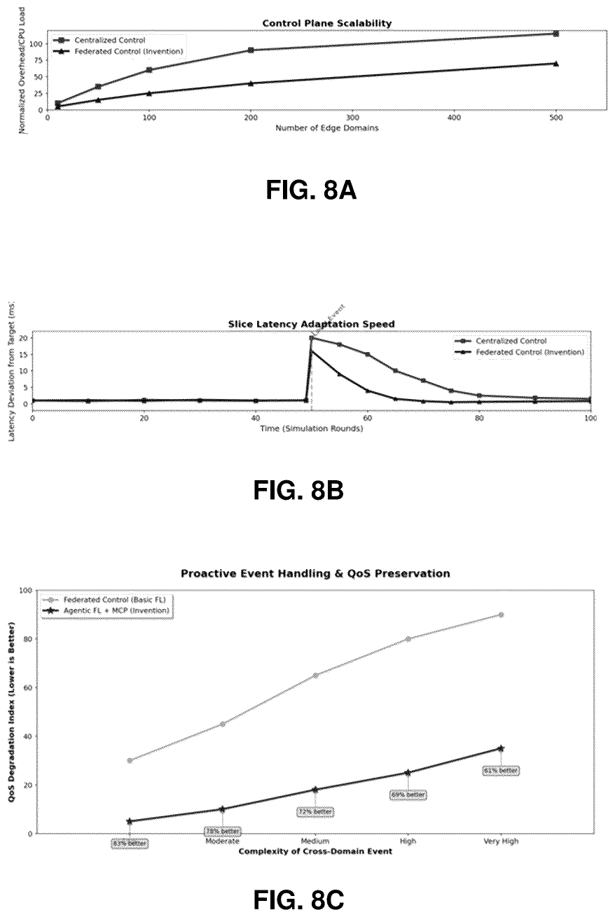

FIG. 8A depicts an example of control plane scalability. The Centralized Control system shows a significant and steep increase in Normalized Overhead/CPU Load as the number of Edge Domains grows. The trend appears super-linear, indicating that the central controller rapidly becomes a bottleneck with increasing scale. At 500 Edge Domains, the overhead is substantially high. By contrast, the Federated Control system demonstrates a much more gradual and manageable increase in overhead. While there is still growth, the slope is considerably flatter, suggesting superior scalability. Even at 500 Edge Domains, the overhead remains significantly lower than the centralized approach.

The results indicate that the proposed federated control architecture offers vastly superior scalability compared to a traditional centralized model. By distributing the primary control intelligence and training load to the local Edge Domains and only transmitting lightweight model updates, the federated system avoids the communication and processing bottlenecks inherent in centralized designs.

A specific scenario was designed where a high-priority, latency-sensitive network slice (e.g., for a VR application or industrial control) was established in a particular Edge Domain. The systems were allowed to reach a stable operational state, maintaining the slice's latency target. At a predetermined point in the simulation (“Local Event” around simulation round 50), a localized disruptive event was introduced specifically within that Edge Domain (e.g., a sudden burst of contending traffic, simulated degradation of a local link affecting the slice). The primary metric was the “Latency Deviation from Target (ms)” for the affected slice over time. Recovery speed was observed by how quickly this deviation returned to near-zero.

FIG. 8B depicts an example of slice latency adaptation speed. Both systems maintain the slice latency close to its target (low deviation). Latency deviation spikes significantly for both systems as the disruptive event impacts the slice. The initial impact is similar for both. The Federated Control system demonstrates a rapid recovery. The Local Slice Management Agent, empowered by its locally trained AI model (which benefits from the globally learned intelligence), quickly detects the deviation and makes swift, localized adjustments. The latency deviation is brought back to near-target levels within approximately 15-20 simulation rounds post-event (around simulation round 65-70). The Centralized Control system (red line) exhibits a much slower recovery. The latency deviation remains high for a longer period as the system relies on telemetry propagation to the central controller, central decision-making, and command dissemination back to the edge. Even by simulation round 100, the latency has not fully recovered to its pre-event stability, indicating a less agile response. These results highlight the superior responsiveness and adaptability of the federated control system. By enabling local AI-driven decision-making at the edge, faster reactions to local conditions and disruptions can be achieved. This contrasts with the inherent delays of a centralized control loop. The ability of the federated system to quickly restore QoS for critical slices is crucial for latency-sensitive edge applications.

FIG. 8C depicts an example of Proactive Event Handling and QoS Preservation under Increasing Cross-Domain Event Complexity. A multi-edge domain network was simulated, hosting various applications with defined slices (e.g., ultra-low latency VR, high-bandwidth video streaming, critical IoT). A series of predictable, impending “cross-domain events” were designed. These events were designed to stress the network and require coordinated responses spanning multiple edge domains.

Complexity of Cross-Domain Event (X-axis) was varied across scenarios. Increased complexity was defined by factors such as: number of edge domains directly and indirectly impacted, magnitude of the anticipated demand surge or resource constraint, degree of interdependency between slices across the affected domains, and criticality and diversity of QoS requirements for slices in the event zone. Low Complexity can represent a localized, predictable demand surge for a specific service in one edge domain, with minor ripple effects. Moderate/Medium Complexity can represent a scheduled major software update for a popular edge application affecting users across several adjacent domains, requiring temporary resource reallocation and careful traffic management. High/Very High Complexity can represent a large-scale public event (e.g., city-wide festival, major sporting event) announced well in advance, expected to cause massive, geographically widespread demand shifts for multiple services (uplink video, social media, location services) across many interlinked edge domains, potentially overwhelming unprepared infrastructure.

Both systems show an increase in QoS Degradation as the complexity of the cross-domain event increases. This is expected, as more complex events are inherently harder to manage perfectly.

Federated Control (Basic FL) exhibits a relatively high QoS Degradation Index, which rises steeply with increasing event complexity. This suggests that while its FL models might provide some level of adaptation, its lack of explicit, actionable foresight and advanced coordination mechanisms for specific, complex events leads to significant service degradation.

Agentic FL with MCP messaging maintains a lower QoS Degradation Index across all levels of event complexity. Even for Low complexity events, the agentic system is 83% better, indicating superior baseline preparedness or handling of simpler proactive tasks. As complexity increases to Moderate, Medium, High and Very High, significant advantage can be achieved, showing 78%, 72%, 69%, and 61% better performance (less degradation) respectively. The rate of increase in degradation for the agentic system is much shallower than for the basic FL system. This implies that its ability to leverage specific context via MCP for planning and coordination scales more effectively against increasing event complexity.

The results demonstrate the superior proactive event handling capabilities of the “Agentic FL+MCP”. The ability of ALSMEs to receive rich contextual warnings about upcoming events via MCP, share intent, and collaboratively plan and execute resource adjustments before the event significantly mitigates QoS degradation. This is evident in more complex cross-domain scenarios where simple reactive or pattern-based predictive measures (as might be found in the basic FL system) may be insufficient. The consistently lower QoS Degradation Index and the substantial percentage improvements underscore the value of agentic intelligence and semantic context exchange for building resilient and high-performing future networks.

The federated intelligence approach can significantly improve scalability of control plane, for future large-scale edge deployments. Furthermore, federated intelligence approach can enhance the network's ability to adapt rapidly to local events, ensuring better QoS and reliability for demanding edge applications, while offering a more privacy-preserving architecture due to localized data processing. The ability of ALSMEs to receive rich contextual warnings about upcoming events via MCP, share intent, and collaboratively plan and execute resource adjustments before the event significantly mitigates QoS degradation. This is particularly evident in more complex cross-domain scenarios where simple reactive or pattern-based predictive measures (as might be found in the basic FL system) are insufficient. The consistently lower QoS Degradation Index underscores the value of agentic intelligence and semantic context exchange for building resilient and high-performing future networks.

### Energy Management for Agentic Systems

Agentic AI systems (e.g., autonomous robots, collaborative AI assistants, personalized edge agents, or others) can perform decision-making based on multi-operation reasoning and interaction with large language models (LLMs) or other sophisticated AI models. The computational and network demands of these agents can be highly dynamic and substantial and utilize a relatively large carbon footprint.

Various examples that include an AI-driven framework that jointly and proactively adjusts network slice parameters, edge compute resource allocation, and AI model precision (e.g., percentage of times that a model predicted correctly) while adhering to application QoS and SLA parameters that specify energy and carbon utilization. Agentic AI-driven systems (e.g., EcoSlicE) can adjust network slice parameters (e.g., bandwidth, priority) and edge compute resources (e.g., processor allocation, network interface bandwidth, memory allocation, memory bandwidth, AI model precision, or others) to control energy consumption and carbon footprint. EcoSlicE can use integrated power models for network and compute elements, based on real-time energy source carbon intensity data, to meet diverse application QoS requirements at the network edge. EcoSlicE can lower power consumption for a workload during high carbon intensity periods by potentially shifting to lower-precision models or relaxing QoS, if permissible by an applicable policy.

Agentic AI systems can transmit Model Context Protocol (MCP) messages to share the context of AI models (e.g., type of model such as Large Language Models (LLMs), Retrieval-Augmented Generation (RAG), machine learning (ML), rule-based systems, and small language models (SLMs)), including selected AI model parameters (e.g., initial weights, gradients, biases, etc.), and data on energy implications of context processing and guidance on context strategies (e.g., compression or summarization) for a current energy or carbon policy. AI systems can collaborate to reduce energy consumption and carbon footprint while maintaining performance for multi-agent-driven edge applications. Various examples provide carbon-aware network slicing by AI-driven control plane managing network slices, processor power states, and AI model selection in a coordinated fashion for energy efficiency to control power (kWh) consumption or carbon (CO2) footprint for edge applications.

At least for Network Service Providers (NSPs), cloud service providers (CSPs), and enterprises, EcoSlicE can reduce edge deployment operational costs (OPEX) through energy savings, enable sustainable green edge computing by reducing carbon footprint, and improve QoS-per-watt efficiency.

Agentic systems on battery-constrained edge devices (e.g., robots, wearables) can operate longer due to the reduced energy consumption baseline provided by EcoSlicE. Within a fixed power budget (e.g., thermal design power of an edge server), agents can undertake more computationally intensive tasks or utilize more sophisticated AI models. EcoSlicE can enable the deployment of a larger number or more sophisticated agents on a given piece of edge hardware by managing the aggregate energy and carbon footprint. EcoSlicE can adjust one or more of: network slice parameters (e.g., network bandwidth allocation in a 5G User Plane Function (UPF) or network switch); edge compute power states (e.g., processor (e.g. accelerator, CPU, or GPU) frequencies, core power states (C-states), or others); active AI models; and/or reported precision levels (e.g., model output characteristics).

Agents can provide EcoSlicE with high-level semantic information about their current tasks (e.g., “background data sync, delay tolerant” versus “critical navigation computation, low-latency”) and EcoSlicE can make more trade-offs between power usage, carbon footprint, and performance. An agent planning a multiple operations could proactively signal its anticipated future resource needs (e.g., compute, network, context size via MCP messages) to EcoSlicE, enabling preemptive resource provisioning or adjustments. If EcoSlicE signals high carbon intensity or imminent power capping, an agent may switch to a simpler reasoning algorithm, reduce query frequency, or request a more compressed context provided in MCP messages.

AI agents can share telemetry regarding the size, complexity, and processing cost (in terms of compute cycles or memory bandwidth) of the context windows being used by Agentic AI models by transmitting MCP messages and EcoSlicE can determine resource demand among multiple Edge Domains. Based on the overall energy policy, EcoSlicE can provide hints via MCP message for AI agents to adopt specific context management strategies. If a low-power, low-precision AI model is activated by EcoSlicE, EcoSlicE could indicate by MCP messages to use aggressive context summarization or pruning, as the model might not benefit from (or be able to process) a very large, verbose context. If energy is plentiful (e.g., low carbon intensity) and a high-performance model is active, EcoSlicE may transmit MCP messages to AI agents to utilize richer, larger contexts for improved accuracy. AI agents can transmit MCP messages that expose an energy cost profile for different operations (e.g., full context retrieval, delta update, or summarization). EcoSlicE can choose an AI model based on energy cost profile to improve energy-efficiency and meet quality of service.

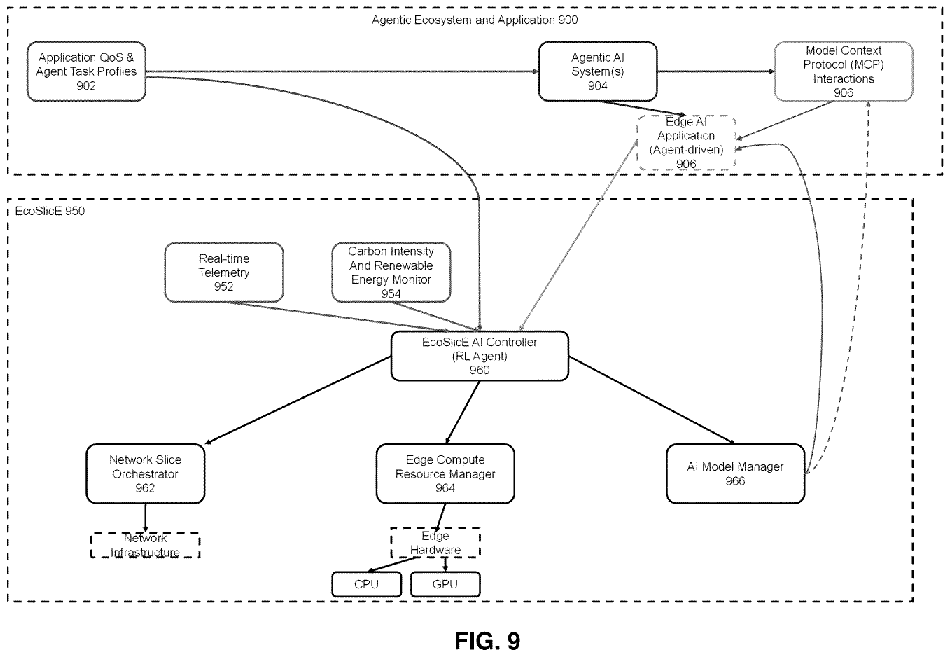

FIG. 9 depicts an example system. Agentic AI systems 904 can negotiate with Reinforcement Learning (RL)-based AI controller 960 and adapt operations based on energy and carbon utilization messaging from AI controller 960. Agentic AI system 904 can transmit MCP messages to AI controller 960 to request energy implications of context processing and guide transmission and content of MCP communications. Agentic AI systems 904 can transmit MCP communications to AI controller 960 to communicate real-time processor power consumption, network interface device or switch power consumption, carbon intensity utilization, AI model power profiles, or others.

Real-time telemetry module 952 can collect telemetry data from network elements (e.g., switches, base stations), edge compute hardware (e.g., power utilization, CPU/GPU utilization), application performance monitors, or others. In some examples, AI controller 960 can receive telemetry 952 (e.g., context size, complexity, processing energy profiles for different context strategies) via MCP messages from agentic AI systems 904.

Carbon intensity and renewable energy monitor 954 can receive real-time or near real-time data on the carbon intensity of the electricity grid or the availability of local renewable sources (e.g., solar panel output, wind turbine power, or others). Based on telemetry 952 and carbon and power utilization data 954, AI controller 960 can provide actionable feedback or hints via MCP messages to agentic AI systems 904 (e.g., “prioritize context compression when energy is X and active model is Y” or “allow larger context if carbon intensity is Z”).

Carbon intensity and renewable energy monitor 954 can utilize predictive models to determine power utilization. For example, compute power, P_compute=P_static_cpu+f(CPU_util, CPU_freq, VPU_active)+P_static_gpu+g(GPU_util, GPU_freq), a model can be trained using telemetry. Network power can include P_network_element=P_static_network_element+h(Throughput, Num_active_ports/carriers) and can be based on device datasheets and empirical measurements. AI controller 960 attributes a portion of network power to each slice based on its utilization.

AI Controller 960 can use a Reinforcement Learning algorithm (e.g., Deep Q-Network (DQN), Proximal Policy Optimization (PPO), or Multi-Agent RL if managing multiple independent edge nodes) to learn policies for energy-efficient resource allocation. AI controller 960 can access state space and action space based on a reward function to determine actions to transmit to agentic AI systems 904. State space can include: per application/slice: requested QoS (latency, throughput, jitter), current measured QoS, current slice parameters (e.g., bandwidth allocation or processor utilization), current AI model ID and precision; for edge node: CPU/GPU utilization, power draw, memory usage, available AI models with pre-profiled performance/power characteristics; for network: link utilization, aggregated power draw of relevant network elements; and for the environment: real-time grid carbon intensity (gCO2eq/kWh), percentage of renewable energy mix. State space can combine network telemetry, compute states, real-time carbon intensity, agent-declared intent/criticality, model characteristics, and MCP operational statistics/profiles.

Action space can allow simultaneous and coordinated control over network slice parameters, compute power states, selection of specific model variants, and indication of a reward function to utilize. The reward function can balance energy, carbon, QoS, agent task success, and the efficiency/cost of power and bandwidth utilization to transmit and process MCP messages.

Action space can include a composite set of actions. Actions can include one or more of the following. Adjust network slice parameters for application i: (ΔBandwidth_i, ΔPriority_i). Adjust edge compute resources for application i's processes: (Target_CPU_Freq_i, Target_GPU_Freq_i, Num_CPU_Cores_i). Select AI model variant for application i from OpenVINO model zoo: (Model_ID_i) (e.g., switch between FP32, INT8, or different distilled architectures).

Reward Function (R) can be multi-objective reward function guides the RL agent to increase QoS while reducing energy and carbon footprint based on state and action space. An example reward function is as follows. R=w_qos*QoS_Score−w_energy*Total_Energy_Consumed−w_carbon*Total_Carbon_Emitted−w_penalty*Penalty_for_SLA_Violation−w_switch*Cost_of_Action,
where:
   w_qos, w_energy, w_carbon, w_penalty, and w_switch are weight values;
   QoS_Score reflects how well application QoS targets are met;
   Total_Energy_Consumed is the sum of compute and attributed network energy consumed;
   Total_Carbon_Emitted is Total_Energy_Consumed*Carbon_Intensity;
   Penalty_for_SLA_Violation is a negative value; and
   Cost_of_Action penalizes frequent changes to prevent instability.

AI controller 960 can provide energy and carbon cost constraint signals to agentic AI systems 904, and agentic AI systems 904, in turn, can adapt behavior (e.g., task complexity, data queries, internal model choice) and signal evolving intent or needs to AI controller 960. AI controller 960 can interact with network slice orchestrator 962, edge compute resource and power manager 964, and an AI model management system 966 for management of network services and edge computation to reduce energy consumption and carbon footprint while maintaining application-specific Quality of Service (QoS).

AI controller 960 can transmit commands to network orchestrator 962 to adjust network resources (e.g., bandwidth, quality of service, or others), commands to edge compute power manager 964 to adjust allocated hardware resources (e.g., accelerator or processor frequency, accelerator or processor power usage, memory allocation, memory bandwidth, or others), and/or commands to agentic AI systems 904 to retain or change AI models or reduce or retain MCP communications.

Network orchestrator 962 can implement decisions from AI controller 960 by configuring network interface devices (e.g., via NETCONF/YANG, P4 runtime, or others). Edge compute resource manager 964 can implement decisions related to processor power states (e.g., frequency control, power control, core allocation). AI model manager 966 can interface with agentic AI systems to dynamically switch between different pre-compiled and AI model variants (e.g., different precisions such as FP32/INT8, or different distilled versions of a base model) based on directions from AI controller 960.

Based on commands to agentic AI systems 904 to change AI models or reduce or retain MCP communications, agentic AI systems 904 could reduce the complexity of tasks, switch to a less resource-intensive internal reasoning model, modify data query patterns to reduce network load, or reduce context length or frequency of context updates via MCP. Conversely, based on commands to agentic AI systems 904 to increase AI model complexity or increase MCP communications, agentic AI systems 904 could increase the complexity of tasks, switch to a more resource-intensive internal reasoning model, modify data query patterns to increase network load, or increase context length or frequency of context updates via MCP. If MCP messages indicate a very large or complex context being processed, AI controller 960 may request a more powerful model version or allocate more resources, balancing this against energy/carbon goals.

MCP communication strategies (e.g., context caching, selective retrieval, summarization algorithms) have an associated energy usage cost. AI controller 960 could signal use of more aggressive context summarization and compression techniques using MCP messages if a lower power AI model is selected.

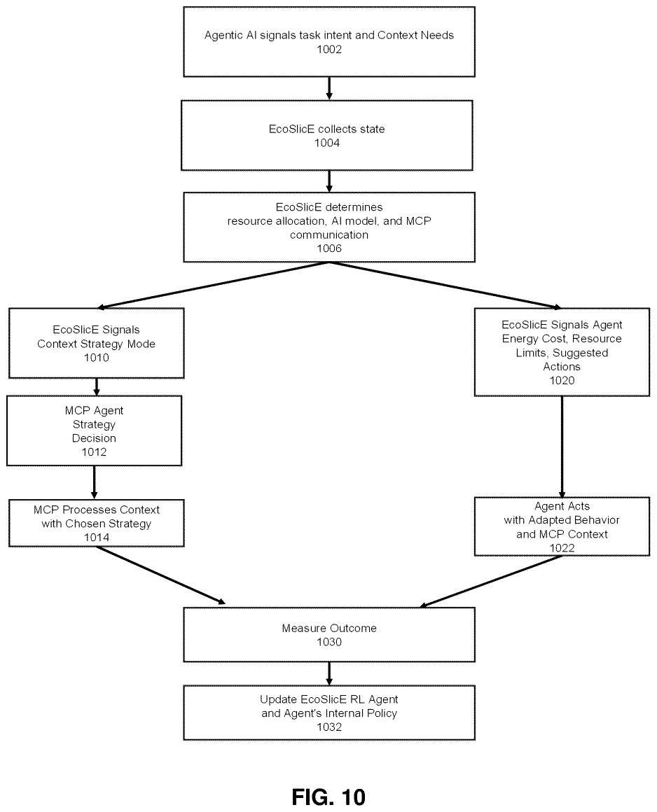

FIG. 10 depicts an example process. At 1002, an agentic AI system can signal its current task intent and context requirements to EcoSlicE AI controller, potentially utilizing a Model Context Protocol (MCP) messages. At 1004, EcoSlicE AI controller can gather state, including telemetry (e.g., network utilization, compute utilization, power utilization or others), prevailing carbon utilization, and specific agentic AI system needs. At 1006, EcoSlicE AI controller can determine a resource allocation strategy, encompassing network slice parameters, edge compute configurations (e.g., processor states), AI model selection, adjusting content and/or frequency in MCP messaging and adherence to energy and carbon policy. At 1008, EcoSlicE can orchestrate parallel threads: operations 1010-1014 to adjust frequency and/or content of context communications via MCP messages (e.g., suggesting MCP message compression if a low-power AI model is active) and operations 1020-1022 to adjust network slices, power states, and deploy the selected AI model.

At 1030, based on the agentic AI system executing its task using the MCP-managed context and within a configured environment, AI controller measures the outcomes, including agentic AI system performance, overall QoS, energy consumed, carbon emitted, and MCP communication efficiency. This feedback is then used to update and refine both the EcoSlicE reinforcement learning agent and, if the agentic AI is adaptive, its internal policies, before the cycle restarts.

At 1032, RL agent can consider higher-level agent intent or task criticality provided by the agentic AI system when making resource allocation decisions. An agentic AI system could signal if its current task is background and delay-tolerant, allowing EcoSlicE to prioritize energy savings more aggressively for that agent's slice/compute for other adaptations to the agentic AI system.

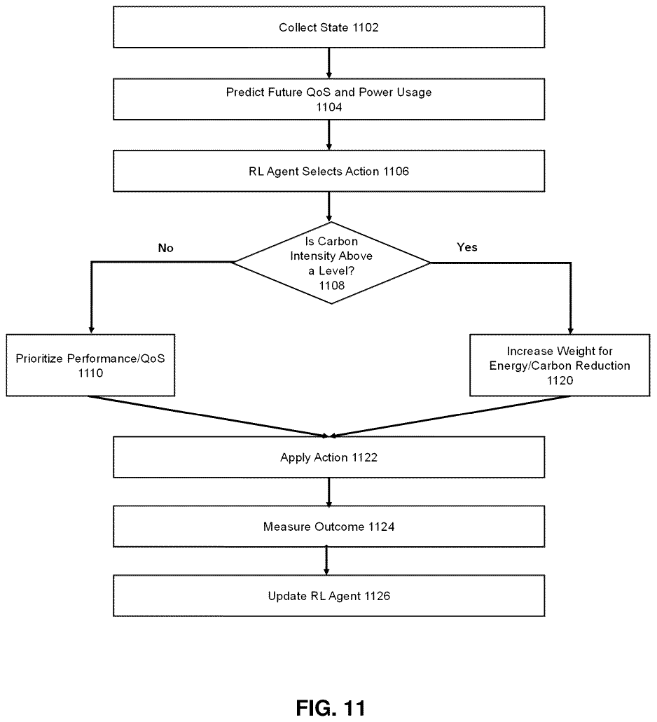

FIG. 11 depicts an example process that can be performed to control carbon utilization by one or more agentic AI agents. The process can be performed by an AI controller, in some examples. At 1102, a telemetry collector and state aggregator can collect state (e.g., QoS, telemetry, power utilization, carbon intensity) of the edge domain. At 1104, a Predictive Model/Engine can predict future QoS and Power (using current action at time t−1). At 1106, RL Agent can select an action (e.g., resource allocation, AI Model, compactness of MCP messaging, or others) for an agentic AI system for the edge domain. At 1208, a determination can be made as to whether carbon intensity is at or above a configured level. Based on the carbon intensity below the configured level, at 1110, RL Agent/Policy can prioritize performance or QoS. When carbon intensity is below the configured level (e.g., high renewable penetration), AI controller can prioritize higher performance, utilize more complex AI models for better accuracy, and/or utilize robust MCP messaging, as the energy consumed has a lower carbon penalty.

Based on the carbon intensity being at or above a configured level, at 1120, the reward function (R) can increase weight for energy/carbon reduction in RL Agent/Policy. The carbon intensity, C_intensity (gCO2eq/kWh), can be a direct input to the RL agent's state and reward function. When C_intensity is high (e.g., grid relying on fossil fuels), the AI controller can be incentivized to take more aggressive energy-saving actions, even if causing operation closer to the lower bounds of QoS, such as selecting AI models that utilize less power, deferring workloads, utilizing simplified AI models, reducing MCP communication frequency and/or size, or scaling down non-critical processing if policies allow.

At 1122, the AI controller can apply an action to configure network, compute, switch AI Model, or other parameters. At 1124, the system monitor/feedback loop can measure outcome, such as QoS, energy usage, carbon usage, or task success metrics. The RL agent can calculate another QoS level, another power level, calculate reward function R(t). At 1126. The EcosliceE AI controller can update RL agent with updated State (St), Action (At), Reward (Rt), Next State (St+1). The RL agent can train with St, At, Rt, St+1 based on previous state, action, reward, next state tuples.

Agentic Local Slice Management Engine (ALSME) can prioritize and execute actions related to energy and power management, balancing efficiency goals against performance and reliability requirements. Various levels of responses are described next. Level 1 operation can be an energy crisis response, a level triggered by critical, immediate power-related events that threaten hardware integrity or service availability. The primary goal is to shed load and preserve core functionality instantly. A trigger can be receiving a high-priority COORDINATION_REQUEST or a critical CONTEXT_ADVISORY. Examples: COORDINATION_REQUEST with action type: SHED_LOAD_IMMEDIATE (from an operator or regional power manager). CONTEXT_ADVISORY with context type: GRID_POWER_LOSS or THERMAL_EMERGENCY_THRESHOLD_BREACHED.

For level 1, an agent can perform triage and feasibility assessment whereby the agent accesses its pre-defined crisis policies and its real-time state to triage services. The agent can determine which slices are designated as non-critical or sheddable, which critical slice (e.g., telemedicine) can be offloaded to a peer agent in a different power domain without violating its SLA, or what is a minimum power state can enter while maintaining life-critical services. Based on the triage, the agent can take an action. The agent can execute power-saving measures and communicates its status. For example, for action On SHED_LOAD_IMMEDIATE, the agent can terminate or throttle pre-defined low-priority slices/applications, aggressively scales down CPU frequencies (e.g., via Intel Speed Shift), and sends a COORDINATION_RESPONSE with status: ACCEPT and a payload detailing the load shed.

For example, for action On GRID_POWER_LOSS, the agent can activate a “battery backup” policy, offloads critical services if possible via a new high-priority COORDINATION_REQUEST (EMERGENCY_OFFLOAD_CRITICAL_SLICE), and gracefully degrades or terminates all other services.

For example, for action On THERMAL_EMERGENCY, the agent can throttle the CPU/VPU, potentially migrating workloads to cooler hardware within its domain, and sends a CONTEXT_ADVISORY to its peers (THERMAL_THROTTLING_ACTIVE_IMPACT_EXPECTED) to warn them of its reduced capacity.

Level 2 can be a proactive and strategic planning (Medium Priority) and can be triggered by intelligence that allows for strategic, planned adjustments to optimize energy consumption without impacting service quality. The focus is on scheduling and anticipation. Triggers can include receiving a CONTEXT_ADVISORY (e.g., PREDICTED_LOW_TRAFFIC_WINDOW, ENERGY_PRICE_SPIKE_ADVISORY, RENEWABLE_ENERGY_SURPLUS_AVAILABLE); receiving a RESOURCE_INTENT from a peer (e.g., another agent intends to enter a low-power state and needs to offload baseline workloads); or receiving a GOAL_UPDATE_NOTIFICATION (e.g., an operator sets a new goal to “Reduce domain energy consumption by 20% during off-peak hours”).

The agent can integrate the new information into its state and analyze the potential impact on its energy and performance goals. The agent can determine: whether to schedule non-time-sensitive workloads (e.g., background model training for FL) to coincide with the RENEWABLE_ENERGY_SURPLUS window; whether to pre-emptively consolidate workloads to minimize active servers during the predicted ENERGY_PRICE_SPIKE; or whether there is capacity to accept the peer's baseline workload without significantly increasing my own costs.

The agent can use its planning algorithms to devise a strategy that reduces energy usage over a specific time horizon as a sequence of scheduled actions. Actions can include Workload Scheduling to create a schedule to migrate all workloads to a single server and place other servers in a deep sleep state during the PREDICTED_LOW_TRAFFIC_WINDOW. Actions can include Policy Adjustment to update local power management policies to favor energy savings over peak performance during specific times. Actions can include Compute Profile Selection to plan to instruct applications (via OpenVINO) to use more energy-efficient AI model versions (e.g., INT8 vs FP16) for non-critical tasks.

The agent can issue MCP communications such as: broadcast a RESOURCE_INTENT to inform peers of its plan (e.g., “INTEND_TO_RELEASE_CAPACITY on servers B and C to enter deep sleep from 02:00-05:00 UTC”); send a COORDINATION_RESPONSE to accept or negotiate a peer's offload request; publish a CONTEXT_ADVISORY based on its plan (e.g., “Domain will operate in low-power mode, non-critical request latency may increase slightly”).

Level 3 can be the agent's default operational state, continuously making micro-adjustments to improve energy efficiency while meeting all performance goals. This is the foundation of its learned efficiency. The agent monitors local telemetry, especially power consumption data from sources such as Intel® RAPL (Running Average Power Limit), and correlates it with processor utilization, slice performance, and application behavior. This data is used to train its local AI model, learning the power-performance trade-offs for its specific hardware and workloads. The agent can contribute these learnings to the global model via Federated Learning. The agent can make autonomous, real-time adjustments to its local domain. The agent can dynamically adjust processor frequencies and core power states (C-states) based on real-time slice demand. Consolidating light workloads onto fewer cores to allow other cores to enter deeper sleep states. Selecting the most energy-efficient network path for non-latency-sensitive traffic.

The agent can contribute to the system's collective energy intelligence by periodically contributing model updates to the FL process, helping create a global model that understands diverse energy-efficiency strategies across different hardware and environments. The MCP message for sharing model updates can include publish CONTEXT_ADVISORY messages based on its local state (e.g., “Current power draw is 15% below baseline due to workload consolidation”).

The MCP message for sharing model updates can include broadcast a CAPABILITY_ADVERTISEMENT to inform other agents of its efficiency capabilities (e.g., “Offering LOW_POWER_ASYNC_COMPUTE for batch processing tasks”).

The implementation of the EcoSlicE system was simulated using a comprehensive environment modeling mixed edge workloads (Augmented Reality and IIoT sensor aggregation), dynamic network conditions, varying edge compute capabilities (based on Intel architectures with OpenVINO for AI model selection), and fluctuating grid carbon intensity data. The following figures detail the performance analysis of the EcoSlicE system based on these simulation results:

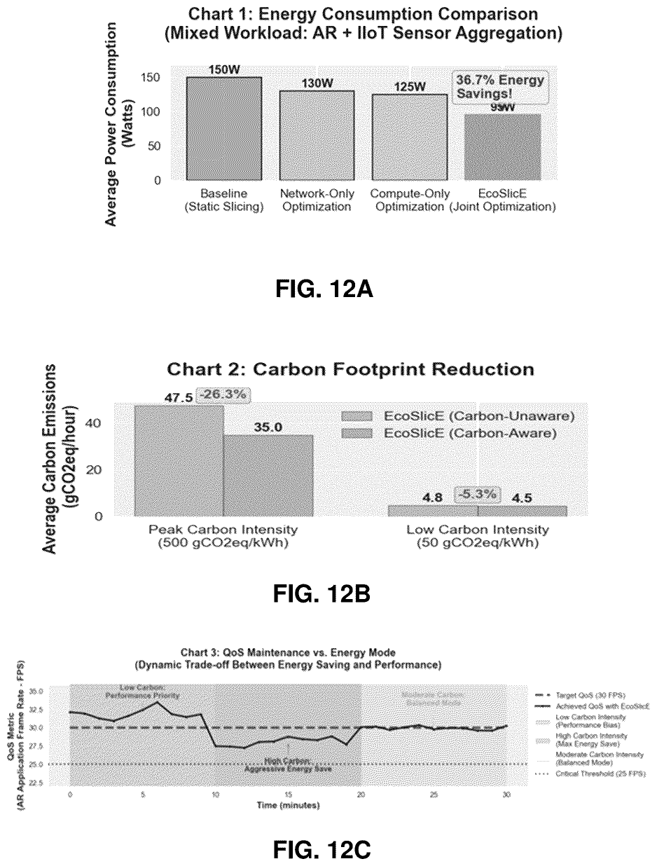

FIG. 12A depicts Energy Consumption Comparison (e.g., Mixed Workload: AR+IIoT Sensor Aggregation). This chart illustrates the average power consumption (in Watts) across different optimization strategies for a combined workload of an Augmented Reality (AR) application and Industrial Internet of Things (IIoT) sensor data aggregation. The baseline scenario, representing static network slicing and default compute settings without advanced power management, consumed an average of 150 W. Implementing Network-Only Optimization (dynamic slicing focused solely on network KPIs) reduced consumption to 130 W. Implementing Compute-Only Optimization (leveraging OpenVINO for AI model switching and CPU/GPU Dynamic Voltage and Frequency Scaling (DVFS) independently) achieved a consumption of 125 W. The EcoSlicE system, employing AI-driven joint optimization of network slice parameters, edge compute resources, and AI model selection, demonstrated superior performance by reducing average power consumption to just 95 W. This represents a significant 36.7% energy saving compared to the baseline.

FIG. 12B depicts an example of carbon footprint reduction. This result clearly shows the substantial benefits of EcoSlicE in reducing energy usage compared to siloed optimization techniques. This chart compares the average carbon emissions (in gCO2eq/hour) under two modes of EcoSlicE operation across different grid carbon intensity levels. During peak carbon intensity (simulated at 500 gCO2eq/kWh), EcoSlicE operating in a Carbon-Unaware mode (optimizing energy efficiency only) resulted in emissions of 47.5 gCO2eq/hour. EcoSlicE in its full Carbon-Aware mode, actively factoring in the high carbon intensity to make more aggressive energy-saving decisions (e.g., selecting lower-precision AI models via OpenVINO), reduced emissions significantly to 35.0 gCO2eq/hour or a 26.3% reduction in carbon footprint compared to the already energy-optimized Carbon-Unaware mode, demonstrating the added value of carbon-intelligent decision-making.

During low carbon intensity (simulated at 50 gCO2eq/kWh), EcoSlicE (Carbon-Unaware) resulted in emissions of 4.8 gCO2eq/hour. EcoSlicE (Carbon-Aware) further reduced emissions to 4.5 gCO2eq/hour. While the absolute savings are smaller due to the lower baseline intensity, an approximate 6.3% additional carbon emission reduction resulted. The chart displays a “−5.3%” label, indicating the further reduction benefit. This chart highlights EcoSlicE's ability to not only save energy but also to strategically manage operations to significantly lessen the environmental impact, particularly when electricity generation is most carbon-intensive.

FIG. 12C depicts an example of QoS Maintenance vs. Energy Mode (Dynamic Trade-off Between Energy Saving and Performance). This chart depicts the dynamic behavior of the EcoSlicE system over 30 minutes, illustrating its ability to manage the QoS (AR Application Frame Rate in frames per second (FPS)) in response to varying carbon intensity levels and associated energy-saving priorities. The target QoS is 30 FPS, with a critical performance threshold of 25 FPS. For 0-10 minutes (Low Carbon: Performance Priority), with low carbon intensity, EcoSlicE prioritizes performance. The achieved QoS consistently remains above the 30 FPS target, averaging around 32-34 FPS, ensuring a high-quality user experience. For 10-20 minutes (High Carbon: Aggressive Energy Save), when carbon intensity increases, EcoSlicE shifts to an aggressive energy-saving mode. This involves proactive measures such as selecting more power-efficient (potentially lower-fidelity but faster) AI models and adjusting compute/network resources. The AR frame rate intelligently dips slightly below the target QoS (around 27-29 FPS) but critically stays above the 25 FPS critical threshold, demonstrating a managed trade-off to achieve substantial energy and carbon savings. For 20-30 minutes (Moderate Carbon: Balanced Mode), with moderate carbon intensity, EcoSlicE can adopt a balanced approach for carbon usage and performance. The achieved QoS stabilizes around the target 30 FPS, for both satisfactory performance and energy efficiency.

The AI controller navigates the complex trade-offs between energy/carbon footprint reduction and application performance, ensuring that QoS violations are minimized and critical performance levels are maintained even when prioritizing sustainability.

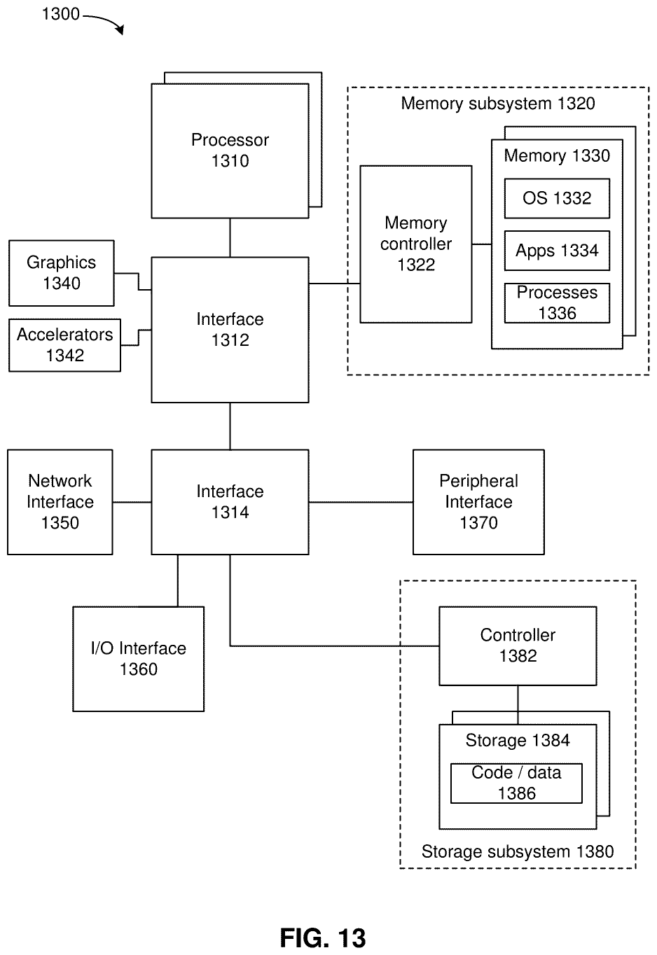

FIG. 13 depicts a system. In some examples, circuitry of system 1300 can be utilized to perform agentic AI systems, AI controller, or to provide resources for execution of slices, as described herein. System 1300 includes processor 1310, which provides processing, operation management, and execution of instructions for system 1300. Processor 1310 can include any type of microprocessor, central processing unit (CPU), graphics processing unit (GPU), XPU, processing core, or other processing hardware to provide processing for system 1300, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1300 includes interface 1312 coupled to processor 1310, which can represent a higher speed interface or a high throughput interface for system components that needs higher bandwidth connections, such as memory subsystem 1320 or graphics interface components 1340, or accelerators 1342. Interface 1312 represents an interface circuit, which can be a standalone component or integrated onto a processor die. Graphics interface 1340 can provide an interface to graphics components for providing a visual display to a user of system 1300. In one example, graphics interface 1340 can drive a display that provides an output to a user. In one example, the display can include a touchscreen display. In one example, graphics interface 1340 generates a display based on data stored in memory 1330 or based on operations executed by processor 1310 or both. In one example, graphics interface 1340 generates a display based on data stored in memory 1330 or based on operations executed by processor 1310 or both.

Accelerators 1342 can be a programmable or fixed function offload engine that can be accessed or used by a processor 1310. For example, an accelerator among accelerators 1342 can provide data compression (DC) capability, cryptography services such as public key encryption (PKE), cipher, hash/authentication capabilities, decryption, or other capabilities or services. In some cases, accelerators 1342 can be integrated into a CPU socket (e.g., a connector to a motherboard or circuit board that includes a CPU and provides an electrical interface with the CPU). For example, accelerators 1342 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1342 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1320 represents the main memory of system 1300 and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

Applications 1334 and/or processes 1336 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1332 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1300 includes interface 1314, which can be coupled to interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface 1350 can include an Ethernet adapter, wireless interconnection components, cellular network interconnection components, USB (universal serial bus), or other wired or wireless standards-based or proprietary interfaces. Network interface 1350 can transmit data to a device that is in the same data center or rack or a remote device, which can include sending data stored in memory. Network interface 1350 can receive data from a remote device, which can include storing received data into memory. In some examples, packet processing device or network interface device 1350 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1300 includes one or more input/output (I/O) interface(s) 1360. I/O interface 1360 can include one or more interface components through which a user interacts with system 1300. Peripheral interface 1370 can include any hardware interface not specifically mentioned above. Peripherals refer generally to devices that connect dependently to system 1300.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (e.g., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (e.g., the value or state of the data is indeterminate if power is interrupted to system 1300). In one example, storage subsystem 1380 includes controller 1382 to interface with storage 1384. In one example controller 1382 is a physical part of interface 1314 or processor 1310 or can include circuits or logic in both processor 1310 and interface 1314.

A volatile memory is memory whose state (and therefore the data stored in it) is indeterminate if power is interrupted to the device. A non-volatile memory (NVM) device is a memory whose state is determinate even if power is interrupted to the device.

In an example, system 1300 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1300 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium, comprising instructions stored thereon, that if executed by one or more processors, cause the one or more processors to: allocate resources to agentic artificial intelligence (AI)-trained systems by: receiving an indication of an upcoming AI model from a first agentic AI-trained system of the agentic AI-trained systems using inter-AI system protocol messages and allocating resources for performance of the upcoming AI model, wherein the resources comprise networking, memory, and compute resources and wherein the agentic AI-trained systems are distributed among different domains and associated with network slices.

Example 2 includes one or more previous or later examples, and includes instructions stored thereon, that if executed by one or more processors, cause the one or more processors to: cause the first agentic AI-trained system, of the agentic AI-trained systems, to update AI parameters with parameters from at least one other of the agentic AI-trained systems.

Example 3 includes one or more previous or later examples, and includes instructions stored thereon, that if executed by one or more processors, cause the one or more processors to: allocate processor and encryption technologies for receipt of the AI parameters and update an AI model of the first agentic AI-trained system based on AI parameters from at least one other of the agentic AI-trained systems.

Example 4 includes one or more previous or later examples, and includes instructions stored thereon, that if executed by one or more processors, cause the one or more processors to: configure the first agentic AI-trained system, of the agentic AI-trained systems, to: receive carbon-based energy parameters and allocate second resources to a network slice based on the carbon-based energy parameters.

Example 5 includes one or more previous or later examples, wherein the allocated second resources comprise one or more of: processor type, processor frequency, processor power usage, memory bandwidth, memory allocation, or network bandwidth allocation.

Example 6 includes one or more previous or later examples, and includes instructions stored thereon, that if executed by one or more processors, cause the one or more processors to: configure the first agentic AI-trained system, of the agentic AI-trained systems, to: perform at least one of: adjust a complexity of an AI model utilized based on carbon-based energy parameters, adjust frequency of communications in the inter-AI system messages based on carbon-based energy parameters, or adjust volume of communications in the inter-AI system messages based on carbon-based energy parameters.

Example 7 includes one or more previous or later examples, wherein the different domains comprise different edge domains.

Example 8 includes one or more previous or later examples, wherein the network slices are consistent with 3rd Generation Partnership Project (3GPP) fifth-generation wireless technology (5G).

Example 9 includes one or more previous or later examples, wherein the inter-AI system protocol messages include at least one of: update to AI model parameters, type of AI model, or input data to AI model used for inference.

Example 10 includes one or more previous or later examples, and includes a method that includes: providing an indication of an upcoming artificial intelligence (AI) model from a first agentic AI-trained system using inter-AI system messages and allocating resources for performance of the upcoming AI model, wherein the resources comprise networking, memory, and compute resources and wherein multiple agentic AI-trained systems are distributed among different domains.

Example 11 includes one or more previous or later examples, and includes the first agentic AI-trained system updating AI parameters with parameters from at least one other of the agentic AI-trained systems.

Example 12 includes one or more previous or later examples, and includes the first agentic AI-trained system providing AI parameters to a memory for storage as encrypted data and the first agentic AI-trained system updating an AI model based on received AI parameters from at least one other of the agentic AI-trained systems, wherein the received AI parameters are based on the provided AI parameters and AI parameters of at least one other agentic AI-trained system.

Example 13 includes one or more previous or later examples, and includes the first agentic AI-trained system receiving carbon-based energy parameters and allocating second resources to a network slice based on the carbon-based energy parameters.

Example 14 includes one or more previous or later examples, wherein the allocated second resources comprise one or more of: processor type, processor frequency, processor power usage, memory bandwidth, memory allocation, or network bandwidth allocation.

Example 15 includes one or more previous or later examples, and includes the first agentic AI-trained system adjusting a complexity of an AI model utilized based on carbon-based energy parameters.

Example 16 includes one or more previous or later examples, and includes the first agentic AI-trained system adjusting frequency or volume of communications in the inter-AI system messages based on carbon-based energy parameters.

Example 17 includes one or more previous or later examples, and includes an apparatus that includes: at least one processor and a memory to store instructions, that when executed by the at least one processor, cause: share artificial intelligence (AI) model parameters from a first agentic AI-trained system using inter-AI system messages and update AI parameters of the first agentic AI-trained system with parameters from at least one other of the agentic AI-trained systems.

Example 18 includes one or more previous or later examples, wherein the memory is to store instructions, that when executed by the at least one processor, cause: the first agentic AI-trained system to provide AI parameters to a memory for storage as encrypted data and the first agentic AI-trained system to update an AI model based on received AI parameters from at least one other of the agentic AI-trained systems, wherein the received AI parameters are based on the provided AI parameters and AI parameters of at least one other agentic AI-trained system.

Example 19 includes one or more previous or later examples, wherein the memory is to store instructions, that when executed by the at least one processor, cause: receive carbon-based energy parameters and allocate resources to a network slice based on the carbon-based energy parameters.

Example 20 includes one or more previous or later examples, wherein the allocated resources comprise one or more of: processor type, processor frequency, processor power usage, memory bandwidth, memory allocation, or network bandwidth allocation.

1. At least one non-transitory computer-readable medium, comprising instructions stored thereon, that if executed by one or more processors, cause the one or more processors to:
allocate resources to agentic artificial intelligence (AI)-trained systems by:
receiving an indication of an upcoming AI model from a first agentic AI-trained system of the agentic AI-trained systems using inter-AI system protocol messages and
allocating resources for performance of the upcoming AI model, wherein the resources comprise networking, memory, and compute resources and wherein the agentic AI-trained systems are distributed among different domains and associated with network slices.

2. The at least one non-transitory computer-readable medium of claim 1, comprising instructions stored thereon, that if executed by one or more processors, cause the one or more processors to:
cause the first agentic AI-trained system, of the agentic AI-trained systems, to update AI parameters with parameters from at least one other of the agentic AI-trained systems.

3. The at least one non-transitory computer-readable medium of claim 2, comprising instructions stored thereon, that if executed by one or more processors, cause the one or more processors to:
allocate processor and encryption technologies for receipt of the AI parameters and
update an AI model of the first agentic AI-trained system based on AI parameters from at least one other of the agentic AI-trained systems.

4. The at least one non-transitory computer-readable medium of claim 1, comprising instructions stored thereon, that if executed by one or more processors, cause the one or more processors to:
configure the first agentic AI-trained system, of the agentic AI-trained systems, to:
receive carbon-based energy parameters and
allocate second resources to a network slice based on the carbon-based energy parameters.

5. The at least one non-transitory computer-readable medium of claim 4, wherein the allocated second resources comprise one or more of: processor type, processor frequency, processor power usage, memory bandwidth, memory allocation, or network bandwidth allocation.

6. The at least one non-transitory computer-readable medium of claim 1, comprising instructions stored thereon, that if executed by one or more processors, cause the one or more processors to:
configure the first agentic AI-trained system, of the agentic AI-trained systems, to:
perform at least one of: adjust a complexity of an AI model utilized based on carbon-based energy parameters, adjust frequency of communications in the inter-AI system messages based on carbon-based energy parameters, or adjust volume of communications in the inter-AI system messages based on carbon-based energy parameters.

7. The at least one non-transitory computer-readable medium of claim 1, wherein the different domains comprise different edge domains.

8. The at least one non-transitory computer-readable medium of claim 1, wherein the network slices are consistent with 3rd Generation Partnership Project (3GPP) fifth-generation wireless technology (5G).

9. The at least one non-transitory computer-readable medium of claim 1, wherein the inter-AI system protocol messages include at least one of: update to AI model parameters, type of AI model, or input data to AI model used for inference.

10. A method comprising:
providing an indication of an upcoming artificial intelligence (AI) model from a first agentic AI-trained system using inter-AI system messages and
allocating resources for performance of the upcoming AI model, wherein the resources comprise networking, memory, and compute resources and wherein multiple agentic AI-trained systems are distributed among different domains.

11. The method of claim 10, comprising:
the first agentic AI-trained system updating AI parameters with parameters from at least one other of the agentic AI-trained systems.

12. The method of claim 10, comprising:
the first agentic AI-trained system providing AI parameters to a memory for storage as encrypted data and
the first agentic AI-trained system updating an AI model based on received AI parameters from at least one other of the agentic AI-trained systems, wherein the received AI parameters are based on the provided AI parameters and AI parameters of at least one other agentic AI-trained system.

13. The method of claim 10, comprising:
the first agentic AI-trained system receiving carbon-based energy parameters and allocating second resources to a network slice based on the carbon-based energy parameters.

14. The method of claim 13, wherein the allocated second resources comprise one or more of: processor type, processor frequency, processor power usage, memory bandwidth, memory allocation, or network bandwidth allocation.

15. The method of claim 10, comprising:
the first agentic AI-trained system adjusting a complexity of an AI model utilized based on carbon-based energy parameters.

16. The method of claim 10, comprising:
the first agentic AI-trained system adjusting frequency or volume of communications in the inter-AI system messages based on carbon-based energy parameters.

17. An apparatus comprising:
at least one processor and
a memory to store instructions, that when executed by the at least one processor, cause:
share artificial intelligence (AI) model parameters from a first agentic AI-trained system using inter-AI system messages and
update AI parameters of the first agentic AI-trained system with parameters from at least one other of the agentic AI-trained systems.

18. The apparatus of claim 17, wherein the memory is to store instructions, that when executed by the at least one processor, cause:
the first agentic AI-trained system to provide AI parameters to a memory for storage as encrypted data and
the first agentic AI-trained system to update an AI model based on received AI parameters from at least one other of the agentic AI-trained systems, wherein the received AI parameters are based on the provided AI parameters and AI parameters of at least one other agentic AI-trained system.

19. The apparatus of claim 17, wherein the memory is to store instructions, that when executed by the at least one processor, cause:
receive carbon-based energy parameters and allocate resources to a network slice based on the carbon-based energy parameters.

20. The apparatus of claim 19, wherein the allocated resources comprise one or more of: processor type, processor frequency, processor power usage, memory bandwidth, memory allocation, or network bandwidth allocation.
